(19) United States
(12) Patent Application Publication
(10) Pub. No.: US 2024/0244175 A1
(43) Pub. Date: Jul. 18, 2024

(54) STEREOSCOPIC DISPLAY DEVICE

(71) Applicant: SONY GROUP CORPORATION, TOKYO (JP)

(72) Inventors: TOMOYA YANO, TOKYO (JP); TAKAYUKI KURIHARA, TOKYO (JP); HAJIME KIKUHARA, TOKYO (JP)

(21) Appl. No.: 18/577,123

(22) PCT Filed: Jul. 12, 2022
(86) PCT No.: PCT/JP2022/027409

§ 371 Date: Jan. 5, 2024

(30) Foreign Application Priority Data
Jul. 21, 2021 (JP) 2021-120758

(51) Int. Cl. H04N 13/305; H04N 13/317; H04N 13/346; H04N 13/368

(52) U.S. Cl. CPC H04N 13/305; H04N 13/317; H04N 13/346; H04N 13/368

(57) ABSTRACT

A stereoscopic display device according to the present disclosure includes: an image display element that displays a plurality of viewpoint images; an optical element that is opposed to the image display element, and outputs a plurality of light beams corresponding to the respective viewpoint images toward respective viewpoint positions; and an optical filter that is disposed between the optical element and the plurality of view point positions, and controls diffusion angles of the light beams outputted from the optical element in such a manner that the diffusion angles fall within a predetermined angular range decided on the basis of the plurality of viewpoint positions.

### TECHNICAL FIELD

The present disclosure relates to a stereoscopic display device.

### BACKGROUND ART

There have been stereoscopic display devices using a lenticular lens (for example, PTL 1). The PTL 1 proposes a stereoscopic display device in which a diffuser is disposed to reduce moiré.

### CITATION LIST

### Patent Literature

PTL 1: Japanese Unexamined Patent Application Publication No. H09-133893

### SUMMARY OF THE INVENTION

Crosstalk may happen in such a stereoscopic display device using the lenticular lens and a left viewpoint image and a right viewpoint image may be mixed. When using the stereoscopic display device described in the PTL 1, it is difficult to suppress the crosstalk while reducing moiré.

It is desirable to provide a stereoscopic display device that makes it possible to improve image quality.

A first stereoscopic display device according to an embodiment of the present disclosure includes: an image display element that displays a plurality of viewpoint images; an optical element that is opposed to the image display element, and outputs a plurality of light beams corresponding to the respective viewpoint images toward respective viewpoint positions; and an optical filter that is disposed between the optical element and the plurality of view point positions, and controls diffusion angles of the light beams outputted from the optical element in such a manner that the diffusion angles fall within a predetermined angular range decided on the basis of the plurality of viewpoint positions.

A second stereoscopic display device according to an embodiment of the present disclosure includes: an image display element that displays a plurality of viewpoint images; and an optical element that is opposed to the image display element, and outputs a plurality of light beams corresponding to the respective viewpoint images toward respective viewpoint positions. A surface of the optical element is processed to function as an optical filter that controls diffusion angles of the light beams outputted from the optical element in such a manner that the diffusion angles fall within a predetermined angular range decided on the basis of the plurality of viewpoint positions.

The first stereoscopic display device or the second stereoscopic display device according to embodiments of the present disclosure controls the diffusion angles of the light beams outputted from the optical element toward the plurality of viewpoint positions in such a manner that the diffusion angles fall within the predetermined angular range decided on the basis of the plurality of viewpoint positions.

### BRIEF DESCRIPTION OF DRAWING

FIG. 1 is a cross-sectional diagram schematically illustrating a configuration example of a stereoscopic display device according to a first embodiment of the present disclosure in a horizontal direction.

FIG. 2 is an explanatory diagram illustrating an example of a relation between a viewpoint angle and intensity of light at a viewpoint position of the stereoscopic display device.

FIG. 3 is an explanatory diagram illustrating an example of a relation between an observation distance and a viewpoint angle of the stereoscopic display device.

FIG. 4 is a plan view illustrating an example of a pixel configuration of an image display element.

FIG. 5 is a simulation image illustrating an example of a state of pixels observed via a lenticular lens.

FIG. 6 is an explanatory diagram illustrating an example of a state of pixels observed via the lenticular lens.

FIG. 7 is an explanatory diagram illustrating an example of moiré observed via the lenticular lens.

FIG. 8 is a cross-sectional diagram schematically illustrating a configuration example of the stereoscopic display device according to the first embodiment in an axial direction of the lenticular lens.

FIG. 9 is an explanatory diagram schematically illustrating an example of a subpixel pitch in the axial direction of the lenticular lens.

FIG. 10 is a plan view illustrating an example of an arrangement relation between the lenticular lens and pixels of the image display element.

FIG. 11 is a cross-sectional diagram schematically illustrating a configuration example of a stereoscopic display device according to a first specific example in the horizontal direction.

FIG. 12 is a cross-sectional diagram schematically illustrating a modification of the stereoscopic display device according to the first specific example in the horizontal direction.

FIG. 13 is a simulation image illustrating an example of a state of pixels observed in a case where an optical filter is omitted from the stereoscopic display device according to the first specific example.

FIG. 14 is a simulation image illustrating an example of a state of moiré observed in the case where the optical filter is omitted from the stereoscopic display device according to the first specific example.

FIG. 15 is a cross-sectional diagram schematically illustrating a configuration example of a stereoscopic display device according to a second specific example in the horizontal direction.

FIG. 16 is a cross-sectional diagram schematically illustrating a modification of the stereoscopic display device according to the second specific example in the horizontal direction.

FIG. 17 is a simulation image illustrating an example of a state of pixels observed in a case where an isotropic diffuser plate is used as a diffuser plate of the optical filter in the stereoscopic display device according to the second specific example.

FIG. 18 is a simulation image illustrating an example of a state of pixels observed in a case where an anisotropic diffuser plate is used as the diffuser plate of the optical filter in the stereoscopic display device according to the second specific example.

FIG. 19 is a cross-sectional diagram schematically illustrating a configuration example of a stereoscopic display device according to a third specific example in the horizontal direction.

FIG. 20 is a configuration diagram schematically illustrating a configuration example of a trapezoidal prism array serving as an optical filter of the stereoscopic display device according to the third specific example.

FIG. 21 is a cross-sectional diagram schematically illustrating a configuration example of the trapezoidal prism array serving as the optical filter of the stereoscopic display device according to the third specific example.

FIG. 22 is a simulation image illustrating an example of a state of pixels and a state of moiré that are observed in a case where the optical filter is omitted from the stereoscopic display device according to the third specific example.

FIG. 23 is a simulation image illustrating an example of a state of pixels and a state of moiré that are observed in the stereoscopic display device according to the third specific example.

FIG. 24 is a configuration diagram schematically illustrating a configuration example of a trapezoidal prism array serving as an optical filter of a stereoscopic display device according to the fourth specific example.

FIG. 25 is a simulation image illustrating an example of a state of pixels observed in a case where an optical filter is omitted from the stereoscopic display device according to the fourth specific example.

FIG. 26 is a simulation image illustrating an example of a state of pixels observed in the stereoscopic display device according to the fourth specific example.

FIG. 27 is a cross-sectional diagram schematically illustrating a configuration example of a stereoscopic display device according to a fifth specific example in the horizontal direction.

FIG. 28 is a configuration diagram schematically illustrating a configuration example of a lens array serving as an optical filter of the stereoscopic display device according to the fifth specific example.

FIG. 29 is a cross-sectional diagram schematically illustrating a configuration example of the lens array serving as the optical filter of the stereoscopic display device according to the fifth specific example.

FIG. 30 is a simulation image illustrating an example of a state of pixels observed in a case where the optical filter is omitted from the stereoscopic display device according to the fifth specific example.

FIG. 31 is a simulation image illustrating an example of a state of pixels observed in the stereoscopic display device according to the fifth specific example.

FIG. 32 is a configuration diagram schematically illustrating a configuration example of a lens array serving as an optical filter of a stereoscopic display device according to a sixth specific example.

FIG. 33 is a cross-sectional diagram schematically illustrating a configuration example of a stereoscopic display device according to a seventh embodiment in an axial direction of a lenticular lens.

FIG. 34 is a cross-sectional diagram schematically illustrating a configuration example of an optical filter of the stereoscopic display device according to the seventh specific example.

FIG. 35 is a cross-sectional diagram schematically illustrating a modification of the optical filter of the stereoscopic display device according to the seventh specific example.

FIG. 36 is a simulation image illustrating an example of a state of pixels observed via the lenticular lens in a case where the optical filter is omitted from the stereoscopic display device according to the seventh specific example.

FIG. 37 is a simulation image illustrating an example of a state of pixels and a state of moiré that are observed in a case where the optical filter is omitted from the stereoscopic display device according to the seventh specific example.

FIG. 38 is a simulation image illustrating an example of a state of pixels and a state of moiré that are observed in the stereoscopic display device according to the seventh specific example.

FIG. 39 is an explanatory diagram illustrating a relation among a prism pitch of the optical filter in the axial direction of the lenticular lens, a diffusion angle of the optical filter in the axial direction of the lenticular lens, and moiré, with regard to the stereoscopic display device according to the seventh specific example.

FIG. 40 is an explanatory diagram illustrating a relation among a prism pitch of the optical filter in the axial direction of the lenticular lens, an optimal condition for the prism pitch of the optical filter, and moiré, with regard to the stereoscopic display device according to the seventh specific example.

FIG. 41 is an explanatory diagram illustrating a relation among an observation distance, a diffusion angle of the optical filter in the axial direction of the lenticular lens, and moiré, the relation being obtained in a case where the prism pitch is 30 μm with regard to the stereoscopic display device according to the seventh specific example.

FIG. 42 is an explanatory diagram illustrating a relation among an observation distance, a diffusion angle of the optical filter in the axial direction of the lenticular lens, and moiré, the relation being obtained in a case where the prism pitch is 26.6 μm with regard to the stereoscopic display device according to the seventh specific example.

FIG. 43 is an explanatory diagram illustrating influence of diffraction caused by narrowing the array pitch of the optical filter.

FIG. 44 is an explanatory diagram illustrating influence of diffraction caused by narrowing the array pitch of the optical filter.

FIG. 45 is a cross-sectional diagram schematically illustrating a configuration example of an optical filter using a triangle prism array.

FIG. 46 is a cross-sectional diagram schematically illustrating a configuration example of an optical filter using a trapezoidal prism array.

FIG. 47 is a cross-sectional diagram schematically illustrating a configuration example of an optical filter using a lens array.

FIG. 48 is an explanatory diagram illustrating an example of a relation between phase difference and diffraction intensity of the optical filter.

FIG. 49 is an explanatory diagram illustrating an example of an angular distribution of light beams output from an optical filter.

FIG. 50 is an explanatory diagram illustrating an example of an angular distribution of light beams output from an optical filter.

FIG. 51 is an explanatory diagram illustrating an example of an angular distribution of light beams output from an optical filter.

FIG. 52 is a perspective view schematically illustrating a configuration example of a trapezoidal prism array used as an optical filter 4 of a stereoscopic display device according to an eighth specific example.

FIG. 53 is a cross-sectional diagram schematically illustrating a configuration example of a trapezoidal prism.

FIG. 54 is an explanatory diagram illustrating an example of an angular distribution of light beams output from an optical filter in a case where a trapezoidal prism array is used as the optical filter.

FIG. 55 is a perspective view schematically illustrating a configuration example of a triangle prism array used as the optical filter of the stereoscopic display device according to the eighth specific example.

FIG. 56 is an explanatory diagram illustrating an example of an angular distribution of light beams output from an optical filter in a case where a triangle prism array is used as the optical filter.

FIG. 57 is a simulation image illustrating an example of a state of moiré observed in a case where the stereoscopic display device according to the eighth specific example includes no optical filter, and a state of moiré observed in a case where the stereoscopic display device according to the eighth specific example includes an optical filter.

FIG. 58 is a perspective view schematically illustrating a configuration example of a lens array used as the optical filter of the stereoscopic display device according to the eighth specific example.

FIG. 59 is an explanatory diagram illustrating an example of an angular distribution of light beams output from an optical filter in a case where a lens array is used as the optical filter.

FIG. 60 is a perspective view schematically illustrating a configuration example of a lens array used as an optical filter of a stereoscopic display device according to a ninth specific example.

FIG. 61 is a cross-sectional diagram illustrating a comparison between a general cylindrical lens and a blazed cylindrical lens.

FIG. 62 is a plan view schematically illustrating a configuration example of an optical filter of a stereoscopic display device according to a tenth specific example.

FIG. 63 is a cross-sectional diagram schematically illustrating a configuration example of an optical filter of a stereoscopic display device according to an 11th specific example.

FIG. 64 is an explanatory diagram illustrating interface reflectance of a triangle prism array of the optical filter of the stereoscopic display device according to the 11th specific example.

FIG. 65 is a cross-sectional diagram schematically illustrating a configuration example in which the optical filter of the stereoscopic display device according to the 11th specific example includes a uniform intermediate layer.

FIG. 66 is a cross-sectional diagram schematically illustrating a configuration example in which the optical filter of the stereoscopic display device according to the 11th specific example includes a non-uniform intermediate layer.

FIG. 67 is a perspective view schematically illustrating a first configuration example of an optical filter of a stereoscopic display device according to a 12th specific example.

FIG. 68 is a perspective view schematically illustrating a second configuration example of the optical filter of the stereoscopic display device according to the 12th specific example.

FIG. 69 is a perspective view schematically illustrating a first configuration example of ab optical filter of a stereoscopic display device according to a 13th specific example.

FIG. 70 is a perspective view schematically illustrating a second configuration example of the optical filter of the stereoscopic display device according to the 13th specific example.

FIG. 71 is an explanatory diagram schematically illustrating an example of phase difference distributions of phase difference caused with regard to a first configuration example of an optical filter of a stereoscopic display device according to a 14th specific example.

FIG. 72 is an explanatory diagram schematically illustrating an example of a phase difference distribution of phase difference caused with regard to the first configuration example of the optical filter of the stereoscopic display device according to the 14th specific example.

FIG. 73 is an explanatory diagram schematically illustrating an example of a phase difference distribution of phase difference caused with regard to a second configuration example of the optical filter of the stereoscopic display device according to the 14th specific example.

FIG. 74 is an explanatory diagram schematically illustrating an example of phase difference distributions of phase difference caused with regard to the second configuration example of the optical filter of the stereoscopic display device according to the 14th specific example.

FIG. 75 is a cross-sectional diagram schematically illustrating a configuration example of a stereoscopic display device according to a second embodiment.

FIG. 76 is a cross-sectional diagram schematically illustrating a first configuration example of a surface of a lenticular lens of the stereoscopic display device according to the second embodiment.

FIG. 77 is a configuration diagram schematically illustrating a second configuration example of a surface of the lenticular lens of the stereoscopic display device according to the second embodiment.

### MODES FOR CARRYING OUT THE INVENTION

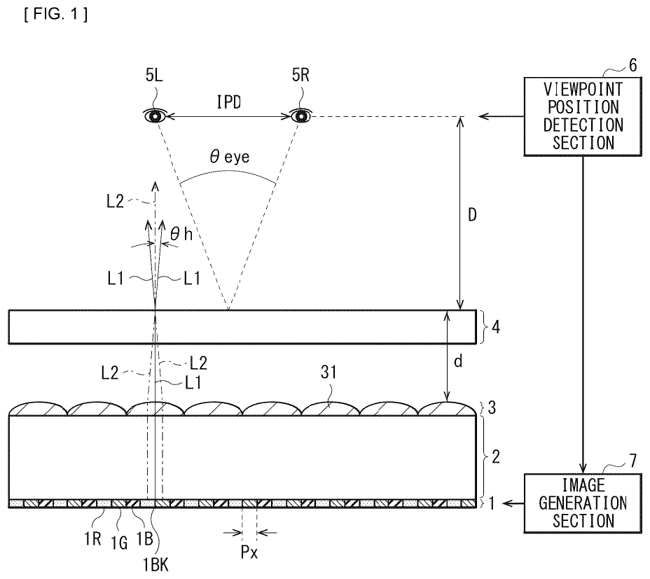

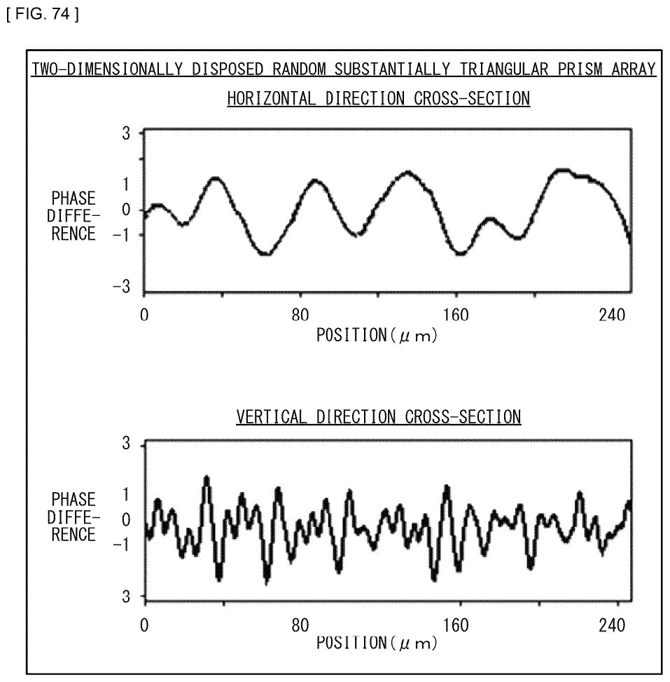

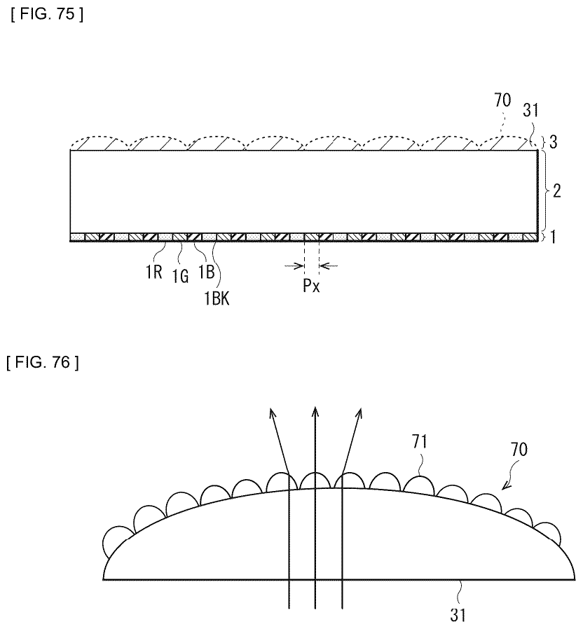

Next, with reference to drawings, details of embodiments of the present disclosure will be described. It is to be noted that the description will be given in the following order.
1. First Embodiment (Stereoscopic Display Device including Optical Filter) (FIG. 1 to FIG. 74)
1.1 Overview
1.2 Specific Examples
1.3 Effects
2. Second Embodiment (Stereoscopic Display Device having Optical Filter Function on Surface of Lenticular Lens) (FIG. 75 to FIG. 77)
3. Other Embodiments

### 1. First Embodiment

### 1.1 Overview

### (Configuration)

FIG. 1 is a cross-sectional diagram schematically illustrating a configuration example of a stereoscopic display device according to the first embodiment of the present disclosure in a horizontal direction.

The stereoscopic display device according to the first embodiment includes an image display element 1, a transparent substrate 2, a lenticular lens 3, an optical filter 4, a viewpoint position detection section 6, and an image generation section 7. The lenticular lens 3 serves as an optical element.

The viewpoint position detection section 6 detects positions of a left eye 5L and a right eye 5R as a plurality of viewpoint positions of an observer. The viewpoint position detection section 6 of the stereoscopic display device according to the first embodiment is able to track the plurality of viewpoint positions of the observer.

The image generation section 7 generates, for example, a viewpoint image for the left eye 5L and a viewpoint image for a right eye 5R as the plurality of viewpoint images. The image generation section 7 generates viewpoint images corresponding to viewpoint positions detected by the viewpoint position detection section 6.

The image display element 1 displays the plurality of viewpoint images generated by the image generation section 7. The image display element 1 includes a plurality of pixels that is arranged two-dimensionally. The plurality of pixels each includes a plurality of subpixels. For example, the plurality of subpixels includes an R (red) color pixel 1R, a G (green) color pixel 1G, and a B (blue) color pixel 1B. A black matrix 1BK is disposed between the subpixels.

The lenticular lens 3 is opposed to the image display element 1 with the transparent substrate 2 interposed therebetween. For example, the lenticular lens 3 includes a plurality of cylindrical lenses 31 that is disposed to be inclined. The cylindrical lenses 31 extend in an inclination direction (axial direction) of the lenticular lens 3. The lenticular lens 3 outputs a plurality of light beams toward the respective viewpoint positions. The plurality of light beams corresponds to the respective viewpoint images displayed on the image display element 1. For example, the lenticular lens 3 outputs a light beam corresponding to a viewpoint image for the left eye 5L displayed on the image display element 1, toward a viewpoint position of the left eye 5L. In addition, for example, the lenticular lens 3 outputs a light beam corresponding to a viewpoint image for the right eye 5R displayed on the image display element 1, toward a viewpoint position of the right eye 5R.

The optical filter 4 is disposed between the lenticular lens 3 and the plurality of viewpoint positions (left eye 5L and right eye 5R). The optical filter 4 controls diffusion angles of the light beams outputted from the lenticular lens 3 in such a manner that the diffusion angles fall within a predetermined angular range decided on the basis of the plurality of viewpoint positions.

### (Actions and Detailed Configuration of Optical Filter 4)

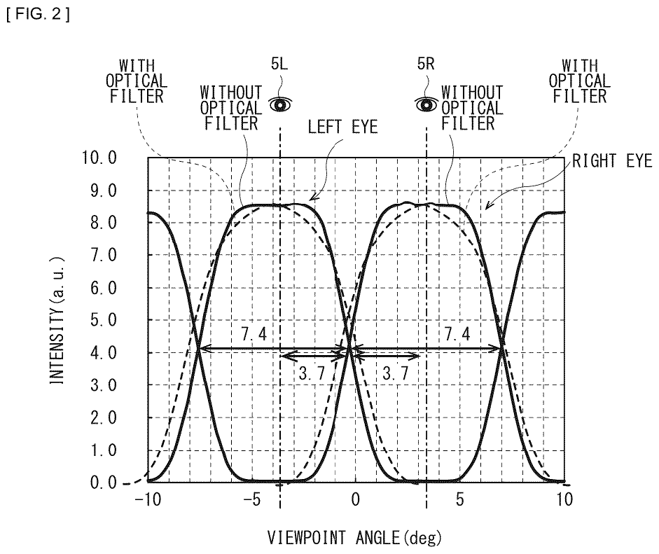

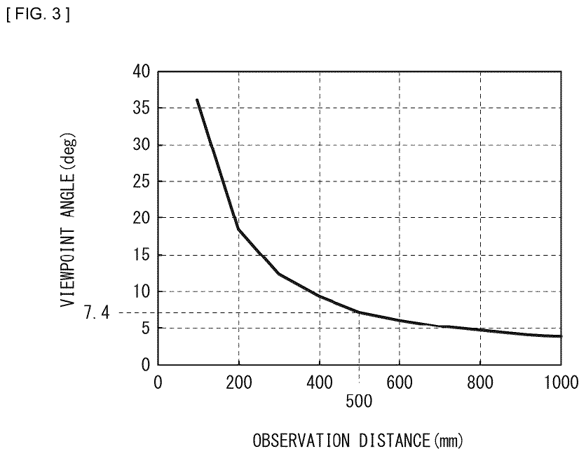

FIG. 2 illustrates an example of a relation between a viewpoint angle θeye and intensity of light at a viewpoint position of the stereoscopic display device. FIG. 3 illustrates an example of a relation between the viewpoint angle θeye and an observation distance of the stereoscopic display device.

The optical filter 4 has a suppressive action on crosstalk while reducing moiré. The moiré is a light and dark stripe obtained when a periodic structure of the lenticular lens 3 interferes with a pixel shape. The light and dark stripe is generated because places where the black matrix 1BK is located form dark sections and the places are spatially biased when the pixels of the image display element 1 is observed from the viewpoint positions via the lenticular lens 3.

The optical filter 4 adds angular spreading to the light beams outputted from the lenticular lens 3. Here, the optical filter 4 includes an element having a function of controlling an output angle of a light beam into a predetermined angle. Examples of the element include a diffuser plate with a controlled scattering angle, an optical low-pass filter, and the like. At this time, with regard to a certain pixel position, one of the eyes (for example, the left eye 5L) receives a light beam outputted from almost one point in a case where the optical filter 4 is not prepared. However, in a case where the optical filter 4 is prepared, the eye receives light beams outputted from not only the one point but also pixel positions around the one point. The same applies to the position of the black matrix 1BK. In the case where the optical filter 4 is prepared, one of the eyes (for example, the left eye 5L) receives a light beam (light beam L1 in FIG. 1) outputted from a certain black matrix 1BK and light beams (for example, light beams L2 in FIG. 1) outputted from pixel positions around the black matrix 1BK. In the case where the optical filter 4 is prepared, it is also possible to decrease contrast of moiré by performing averaging using light beams from pixel positions around a black matrix 1BK at a position where the black matrix 1BK is located.

Meanwhile, if the angular spreading added by the optical filter 4 is too wide, the light beams enter the other eye (for example, the right eye 5R) and this causes crosstalk. To prevent the crosstalk, it is necessary to suppress an allowable angle to a smaller degrees. The allowable angle is decided by the viewpoint angle θeye (angle made by the both eyes and a point on the optical filter 4) decided by the viewpoint positions. FIG. 2 illustrates an angular distribution of intensity of light that enters the left eye 5L and the right eye 5R in a case where observation distance D=500 mm. A solid line indicates a case where the optical filter 4 is not prepared, and a dashed line indicates a case where the optical filter 4 is prepared. It is to be noted that, as illustrated in FIG. 1, the observation distance D is a distance from top surface of the optical filter 4 to the viewpoint positions in the case where the optical filter 4 is prepared. As illustrated in FIG. 3, a viewpoint angle θeye of 7.4 degrees is obtained in a case of the observation distance D=500 mm, and the left eye 5L and the right eye 5R each have a viewpoint width of 7.4 degrees. If it exceeds 3.7 degrees, which is ½ of the viewpoint width, a light beam from one of the eyes enters the other of the eyes and this causes the crosstalk. An actual viewpoint distribution does not have a rectangular shape but has an inclination. In FIG. 2, the allowable angle to avoid worsening the crosstalk is about 2 degrees.

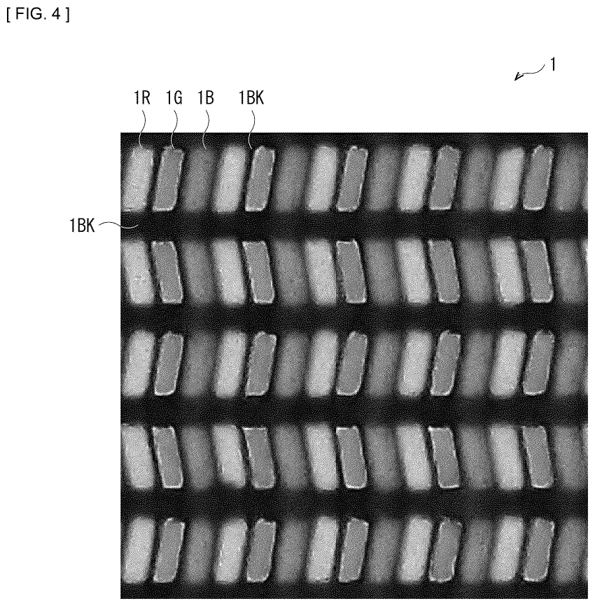

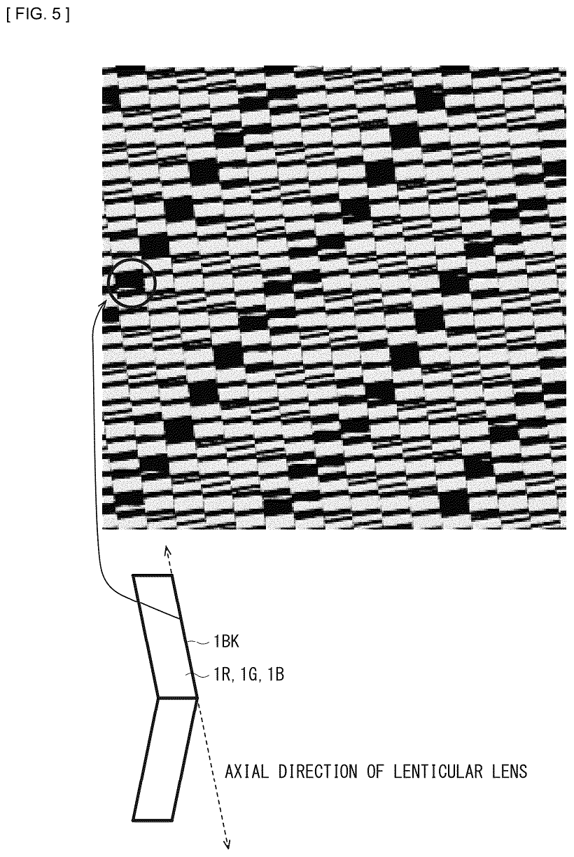

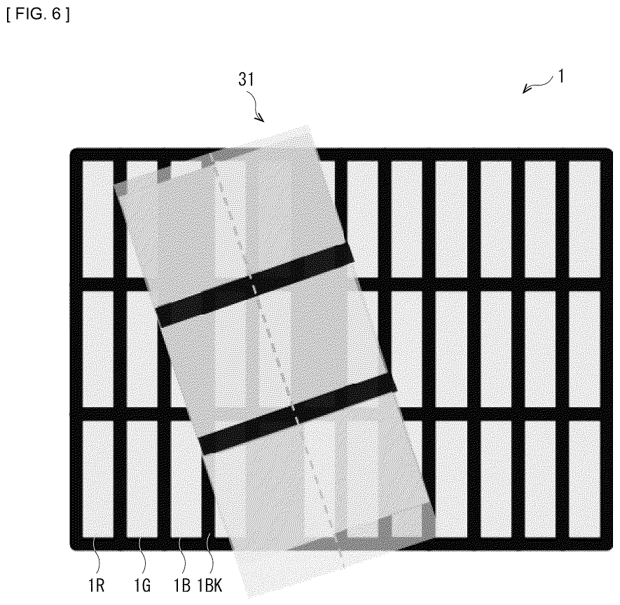

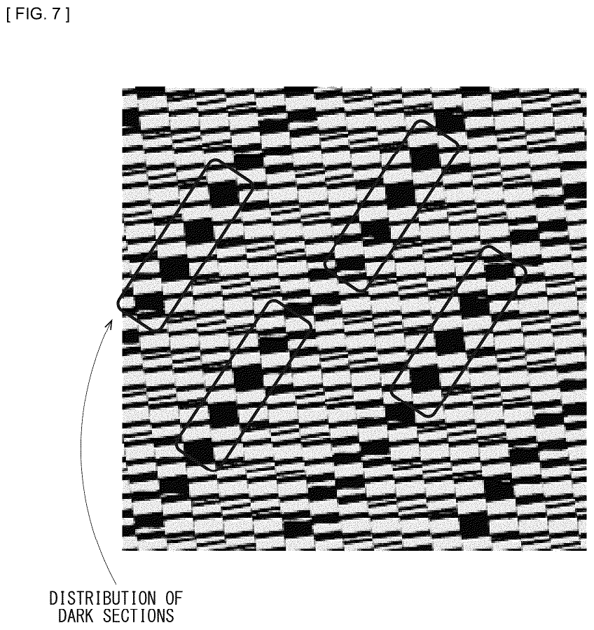

FIG. 4 is a plan view illustrating an example of a pixel configuration of the image display element 1. FIG. 5 is a simulation image illustrating an example of a state of pixels observed via the lenticular lens 3. FIG. 6 is an explanatory diagram illustrating an example of a state of pixels observed via the lenticular lens 3. FIG. 7 is an explanatory diagram illustrating an example of moiré observed via the lenticular lens 3.

FIG. 4 illustrates a pixel structure in an in-plane switching (IPS) mode. As illustrated in FIG. 4, the image display element 1 is configured in such a manner that subpixels have alternated inclination directions every other row. FIG. 5 is the simulation image obtained when pixels are viewed from the viewpoint positions via the lenticular lens 3. In FIG. 5, large-sized dark sections are obtained at positions where the inclination direction of a black matrix 1BK matches the inclination direction (axial direction) of the lenticular lens 3. As illustrated in FIG. 7, the distribution of the dark sections is biased, and this bias is seen as the moiré. It is to be note that FIG. 6 illustrates an example of a state of pixels observed via the lenticular lens 3 while simplifying the pixel structure.

In the case where the observation distance D=500 mm, the viewpoint angle θeye of 7.4 degrees is obtained as described above. The viewpoint angle θeye is decided by the lens pitch of the lenticular lens 3. A focal position of the lenticular lens 3 is designed roughly at a pixel position, and its spatial position on a pixel surface in the horizontal direction corresponds to the angular distribution. In the example illustrated in FIG. 5, a single subpixel is assumed to have a width of about 1.5 degrees when viewed from the viewpoint positions. The dark sections also have angles that roughly fall within this range.

A light beam control angle θh of the optical filter 4 in the horizontal direction is desirably ½ or less of the viewpoint angle θeye made by a surface of the optical filter 4 and the two viewpoint positions corresponding to the left eye position and the right eye position among the plurality of viewpoint positions. In other words, it is possible to achieve both reduction of moiré and suppression of crosstalk by satisfying the followings.
Observation distance: D
Interpupillary distance: IPD
Viewpoint angle: θeye
Light beam control angle in horizontal direction: θh

$$θ eye = 2 {tan}^{- 1} ( IPD / 2 D )$$

$$θ h \leq θ eye / 2$$

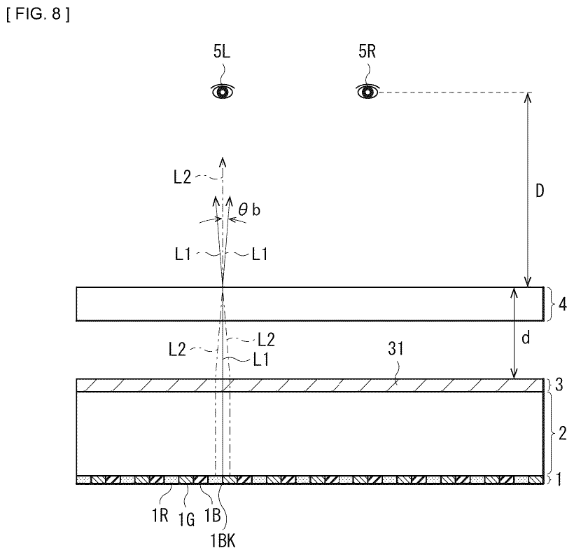

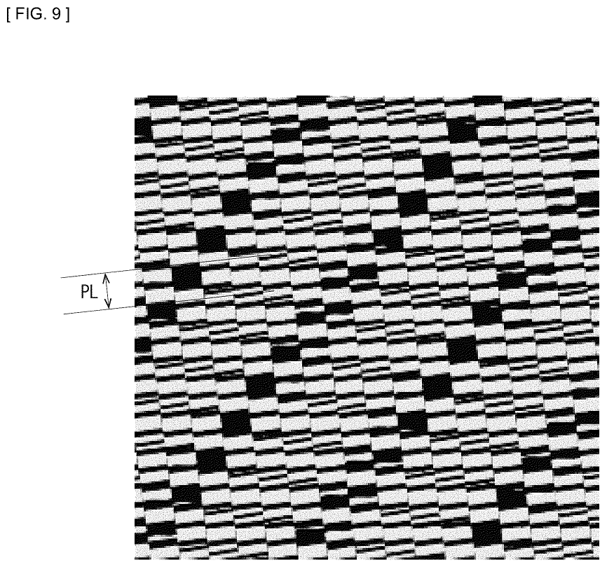

FIG. 8 is a cross-sectional diagram schematically illustrating a configuration example of a stereoscopic display device according to the first embodiment in the axial direction of the lenticular lens 3. FIG. 9 schematically illustrates an example of a subpixel pitch PL in the axial direction of the lenticular lens 3.

FIG. 8 illustrates an example of a light beam control angle θb of the optical filter 4 in the axial direction of the lenticular lens 3. As the light beam control angle θb, FIG. 8 illustrates an example of an angle that spreads after a light beam L1 outputted from a certain black matrix 1BK passes through the optical filter 4. In FIG. 8, dash-dotted lines indicate paths of light beams L2 that is outputted from a plurality of pixels and enters one of the eyes (for example, the left eye 5L). An angle of incidence into the optical filter 4 is the same as the light beam control angle θb. Meanwhile, the subpixel pitch PL in the axial direction of the lenticular lens 3 is decided on the basis of a horizontal size of a subpixel and inclination of the lenticular lens 3.

The optical filter 4 controls averaging within a range of a single subpixel in the axial direction of the lenticular lens 3 to reduce moiré. It is possible to reduce the light beam control angle θb corresponding to a same subpixel range more as a distance d between the top surface of the optical filter 4 and the top surface of the lenticular lens 3 increases.

The light beam control angle θb of the optical filter 4 in the axial direction of the lenticular lens 3 is desirably less than an angle decided by the subpixel pitch PL of the image display element 1 in the axial direction of the lenticular lens 3 and the distance d between the top surface of the optical filter 4 and the top surface of the lenticular lens 3. It is to be noted that the distance d is calculated in terms of distance in air in a case where base material such as glass or transparent resin is disposed between the lenticular lens 3 and a surface that functions as the optical filter 4. The light beam control angle θb of the optical filter 4 in the axial direction of the lenticular lens 3 is calculated as follows.
Subpixel pitch in axial direction of lenticular lens 3: PL
Horizontal subpixel size: Px
Inclination angle of lenticular lens 3: θL
Light beam control angle in the axial direction of lenticular lens 3: θb

$$PL = P x / sin θ L$$

$$θ b = {tan}^{- 1} ( PL / d )$$

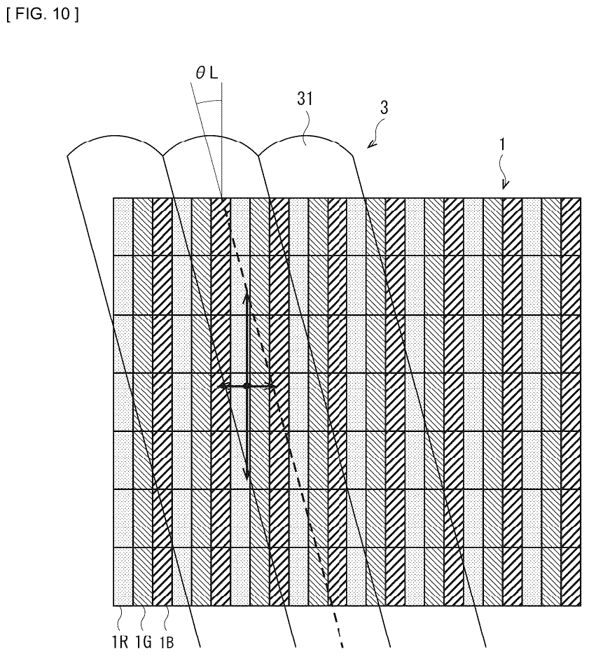

FIG. 10 is a plan view illustrating an example of an arrangement relation between the lenticular lens 3 and pixels of the image display element 1.

The optical filter 4 may have anisotropy with regard to the light beam control angle θh in the horizontal direction and a light beam control angle θv in a vertical direction. As indicated by the following expressions, the light beam control angle θv of the optical filter 4 in the vertical direction may be less than or equal to a value obtained by multiplying ½ of the viewpoint angle θeye by a ratio decided by the inclination angle of the lenticular lens 3, the viewpoint angle θeye being made by the surface of the optical filter 4 and the two viewpoint positions corresponding to the left eye position and the right eye position among the plurality of viewpoint positions. With regard to light beams output from the optical filter 4, angular spreading in the vertical direction has less effect on crosstalk than angular spreading in the horizontal direction. With regard to light beams output from the optical filter 4, an allowable angular range in the vertical direction is tan(90 M−θL) times an allowable angle in the horizontal direction when the lenticular lens 3 has the inclination angle of θL.
Light beam control angle in vertical direction: θv

$$θ eye = 2 {tan}^{- 1} ( IPD / 2 D )$$

$$θ v \leq ( θ eye / 2 ) tan ( 90 - θ L )$$

### 1.2 Specific Examples

Next, detailed configuration examples of the stereoscopic display device according to the first embodiment will be described.

### First Specific Example

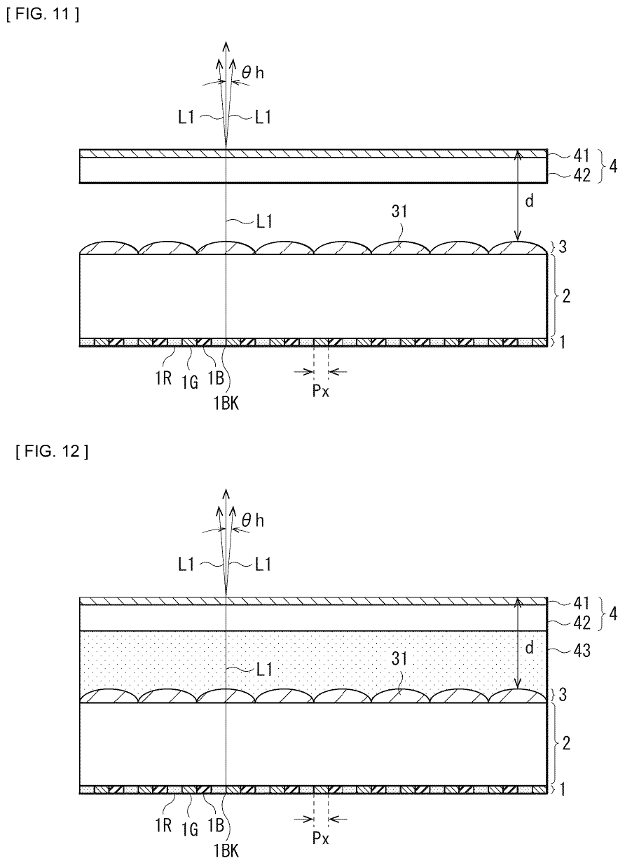

FIG. 11 is a cross-sectional diagram schematically illustrating a configuration example of a stereoscopic display device according to a first specific example in the horizontal direction. FIG. 12 is a cross-sectional diagram schematically illustrating a modification of the stereoscopic display device according to the first specific example in the horizontal direction.

The stereoscopic display device according to the first specific example includes a diffuser plate 41 as the optical filter 4. The diffuser plate 41 has a controlled diffusion angle. The diffuser plate 41 is disposed on a top surface of a transparent substrate 42. The diffuser plate 41 may be integrated with the transparent substrate 42.

It is to be noted that a low refractive index layer 43 may be provided between the lenticular lens 3 and the transparent substrate 42 of the optical filter 4, as exemplified in the modification in FIG. 12. For example, the low refractive index layer 43 includes resin having a lower refractive index than a refractive index of the lenticular lens 3. The low refractive index layer 43 may integrate the lenticular lens 3 and the optical filter 4.

As described above, the light beam control angle θh of the optical filter 4 in the horizontal direction is desirably 3.7 degrees or less. When the light beam control angle θh in the horizontal direction is set to 0.5 degrees, this allows leeway in deviation in tracking the viewpoint positions in respect of crosstalk. The diffuser plate 41 is capable of controlling an output light distribution by using recessed and projected structure on its surface to control a diffusion angle. In addition, the diffuser plate 41 may have a moth-eye antireflective (AR) function.

The diffuser plate 41 may have anisotropy with regard to the light beam control angle θh in the horizontal direction and the light beam control angle θv in the vertical direction. The diffuser plate 41 may also have anisotropy in such a manner that the diffusion angle increases in the axial direction of the lenticular lens 3.

Here, detailed design values of the stereoscopic display device according to the first specific example will be listed.
Diffuser plate 41: light shaping diffuser (LSD) available from Luminit, LLC., for example.
Position of diffuser plate 41: 2.7 mm from top surface of lenticular lens 3
Light beam control angle θh in horizontal direction: ±0.5 degrees (1 degree in full width at half maximum (FWHM))
Optimal observation distance D: 500 mm
Interpupillary distance IPD: 65 mm
Viewpoint angle θeye: 7.41 degrees

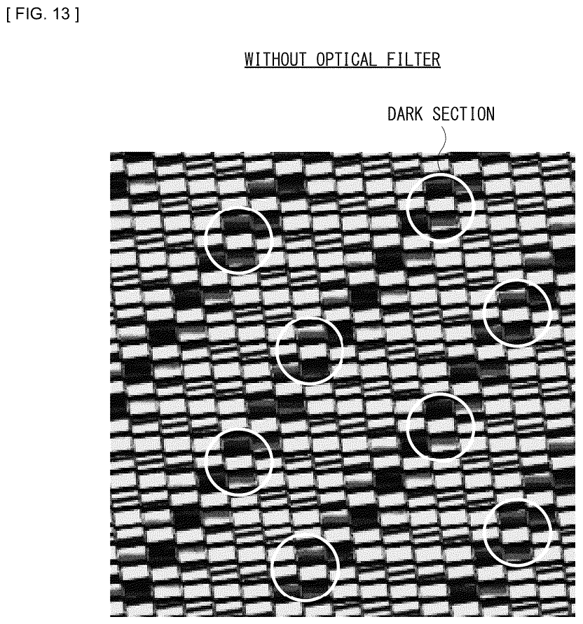

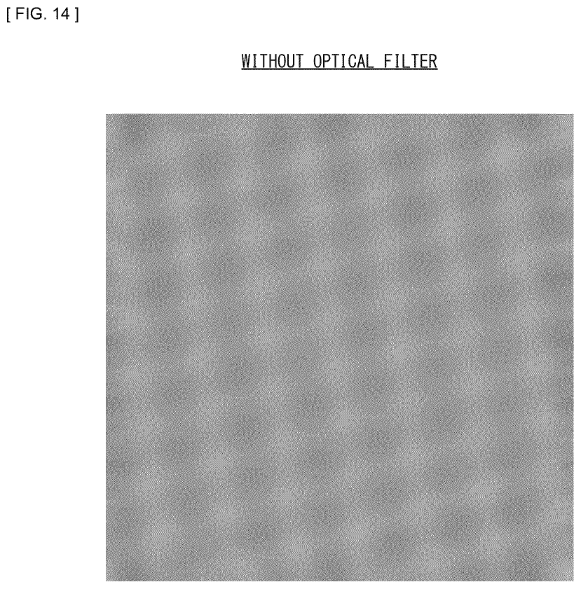

FIG. 13 is a simulation image illustrating an example of a state of pixels observed in a case where the optical filter 4 is omitted from the stereoscopic display device according to the first specific example. FIG. 14 is a simulation image illustrating an example of a state of moiré observed in the case where the optical filter 4 is omitted from the stereoscopic display device according to the first specific example.

When the optical filter 4 including the diffuser plate 41 is disposed, it becomes possible to reduce the sizes of the dark sections (FIG. 13) that are a cause of moiré. This makes it possible to suppress crosstalk while reducing moiré like FIG. 14.

### Second Specific Example

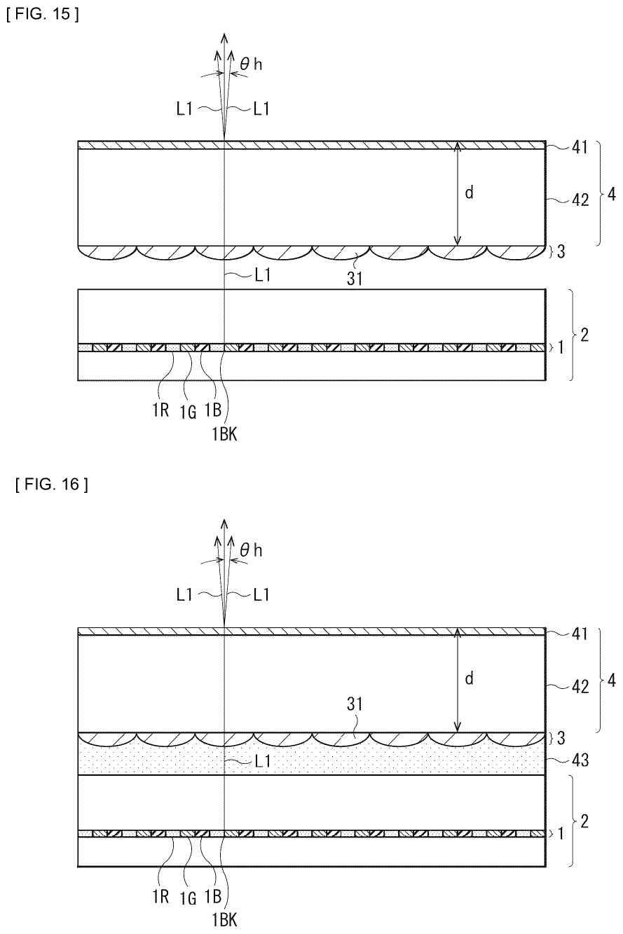

FIG. 15 is a cross-sectional diagram schematically illustrating a configuration example of a stereoscopic display device according to a second specific example in the horizontal direction. FIG. 16 is a cross-sectional diagram schematically illustrating a modification of the stereoscopic display device according to the second specific example in the horizontal direction.

The stereoscopic display device according to the second specific example includes a lenticular lens 3 disposed at a different position from the configuration (FIG. 11) of the stereoscopic display device according to the first specific example. In the stereoscopic display device according to the second specific example, the lenticular lens 3 is disposed on a bottom surface of the transparent substrate 42 of the optical filter 4. The lenticular lens 3 may be integrated with the transparent substrate 42. In addition, the lenticular lens 3 is disposed in such a manner that convex surfaces of cylindrical lenses 31 face downward (side of the image display element 1). In addition, in the stereoscopic display device according to the second specific example, the image display element 1 is disposed inside the transparent substrate 2.

It is to be noted that a low refractive index layer 43 may be provided between the lenticular lens 3 and the transparent substrate 2 in which the image display element 1 is disposed, as exemplified in the modification in FIG. 16. For example, the low refractive index layer 43 includes resin having a lower refractive index than a refractive index of the lenticular lens 3. The low refractive index layer 43 may integrate the lenticular lens 3 and the transparent substrate 2.

In a way similar to the stereoscopic display device according to the first specific example, the diffuser plate 41 is capable of controlling an output light distribution by using recessed and projected structure on its surface to control a diffusion angle. In addition, the diffuser plate 41 may have the moth-eye antireflective (AR) function.

The diffuser plate 41 may have anisotropy with regard to the light beam control angle θh in the horizontal direction and the light beam control angle θv in the vertical direction. The diffuser plate 41 may also have anisotropy in such a manner that the diffusion angle increases in the axial direction of the lenticular lens 3.

Here, detailed design values of the stereoscopic display device according to the second specific example will be listed.
Diffuser plate: (LSD available from Luminit, LLC., for example.
Position of diffuser plate 41: 2.7 mm from top surface of lenticular lens 3
Light beam control angle θh in horizontal direction: ±0.5 degrees (1 degree in FWHM)
Optimal observation distance D: 500 mm
Interpupillary distance IPD: 65 mm
Viewpoint angle θeye: 7.41 degrees

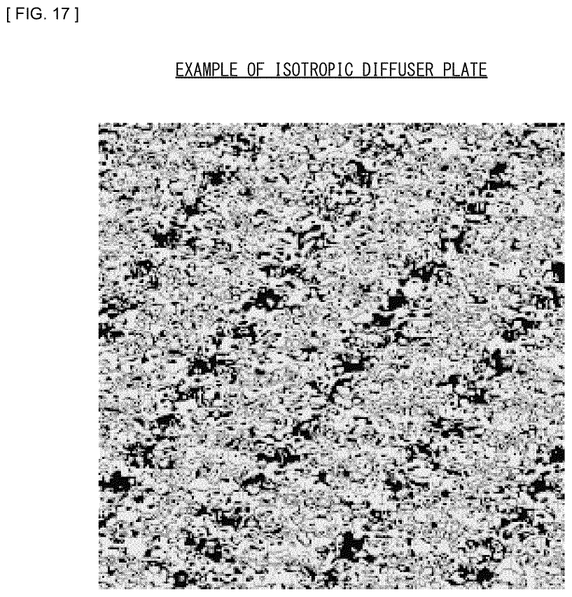

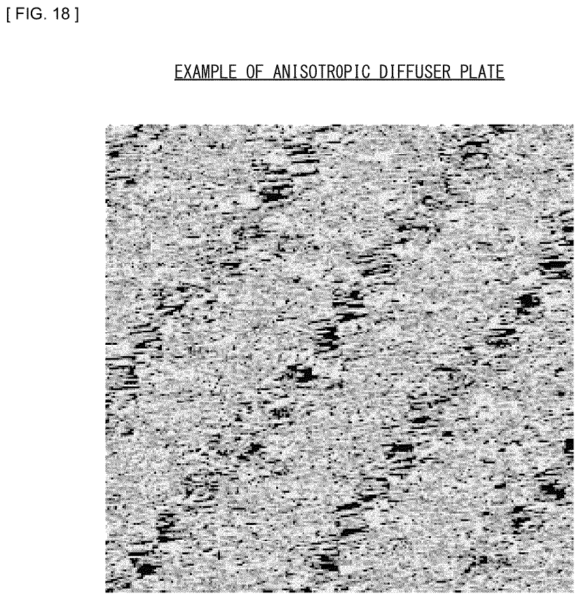

FIG. 17 is a simulation image illustrating an example of a state of pixels observed in a case where an isotropic diffuser plate is used as the diffuser plate 41 of the optical filter 4 in the stereoscopic display device according to the second specific example. FIG. 18 is a simulation image illustrating an example of a state of pixels observed in a case where an anisotropic diffuser plate is used as the diffuser plate 41 of the optical filter 4 in the stereoscopic display device according to the second specific example.

As illustrated in FIG. 17 and FIG. 18, the optical filter 4 including the diffuser plate 41 is disposed, which makes it possible to reduce the sizes of the dark sections that are a cause of moiré. This makes it possible to suppress crosstalk while reducing moiré.

### Third Specific Example

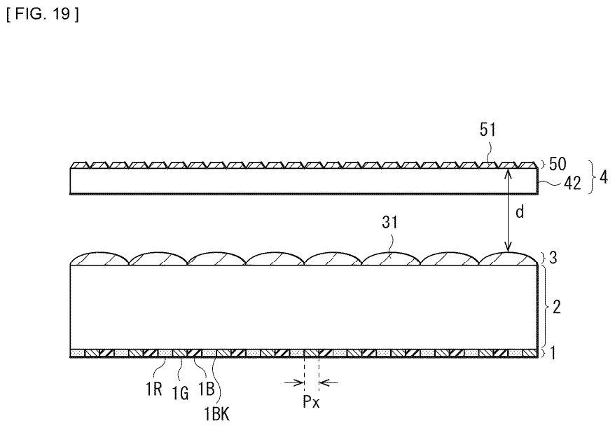

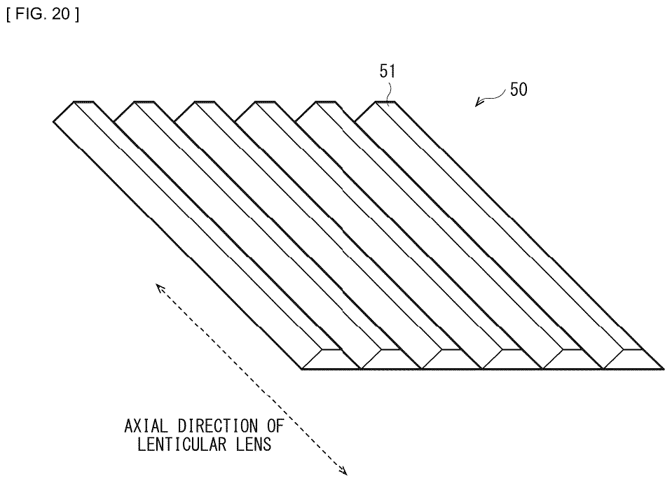

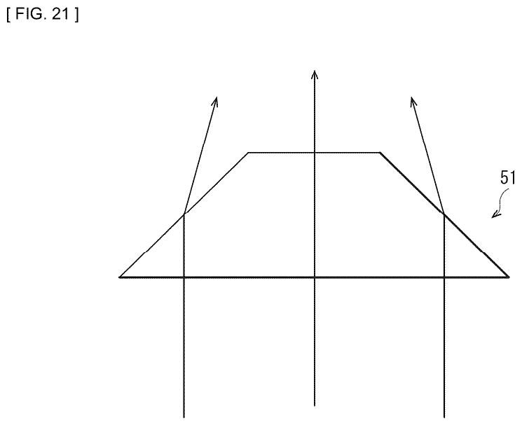

FIG. 19 is a cross-sectional diagram schematically illustrating a configuration example of a stereoscopic display device according to a third specific example in the horizontal direction. FIG. 20 is a configuration diagram schematically illustrating a configuration example of a trapezoidal prism array 50 serving as an optical filter 4 of the stereoscopic display device according to the third specific example. FIG. 21 is a cross-sectional diagram schematically illustrating a configuration example of the trapezoidal prism array 50 serving as the optical filter 4 of the stereoscopic display device according to the third specific example.

The stereoscopic display device according to the third specific example includes the trapezoidal prism array 50 as the optical filter 4. The trapezoidal prism array 50 is disposed on the top surface of the transparent substrate 42. The trapezoidal prism array 50 may be integrated with the transparent substrate 42. The trapezoidal prism array 50 includes a plurality of trapezoidal prisms. The plurality of trapezoidal prisms 51 is parallelly arrayed in a direction parallel to the array of the lenticular lens 3.

Here, detailed design values of the stereoscopic display device according to the third specific example will be listed.
Optimal observation distance D: 500 mm
Viewpoint angle θeye: 7.4 degrees
Lens pitch of lenticular lens 3: 0.143 mm
Array pitch (prism pitch) of trapezoidal prism array 50: 0.04 mm
Position of trapezoidal prism array 50: 2.35 mm from top surface of lenticular lens 3
Light beam control angle θh in horizontal direction: ±0.5 degrees

The light beam control angle θh in the horizontal direction is desirably 3.7 degrees or less. The trapezoidal prisms 51 are designed to have a trapezoidal shape in such a manner that inclined sections in right and left have a ratio of 1/3 and have a predetermined angle of refraction.

The array pitch (prism pitch) of the trapezoidal prism array 50 and the lens pitch of the lenticular lens 3 themselves may serve as causes of moiré depending on a combination condition thereof. The trapezoidal prism array 50 is designed in such a manner that a ratio of the prism pitch of the trapezoidal prism array 50 to the lens pitch of the lenticular lens 3 satisfies the following expression.

$$Ratio = 1 / ( n + 0.5 )$$

where n represents an integer.

In particular, the trapezoidal prism array 50 is designed in such a manner that the ratio satisfies n=3. However, a prism pitch of the trapezoidal prism array 50 viewed from the viewpoint positions is multiplied by a reduction ratio depending on the distance d from the top surface of the lenticular lens 3. An antireflective film may be added to a surface of the trapezoidal prism array 50 as appropriate.

When using the trapezoidal prism array 50 as the optical filter 4, it is possible to suppress crosstalk by accurately controlling the diffusion angle of the optical filter 4 and suppressing spreading of the angular distribution of light beams from the optical filter 4.

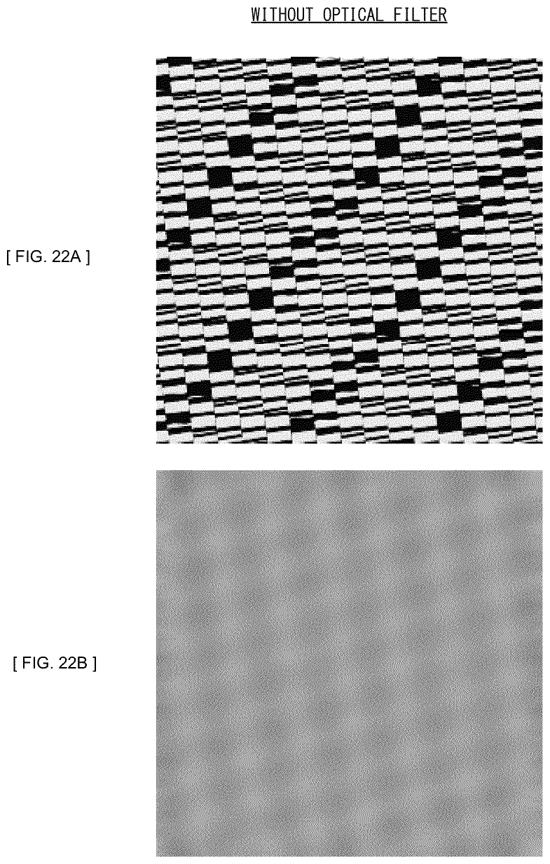

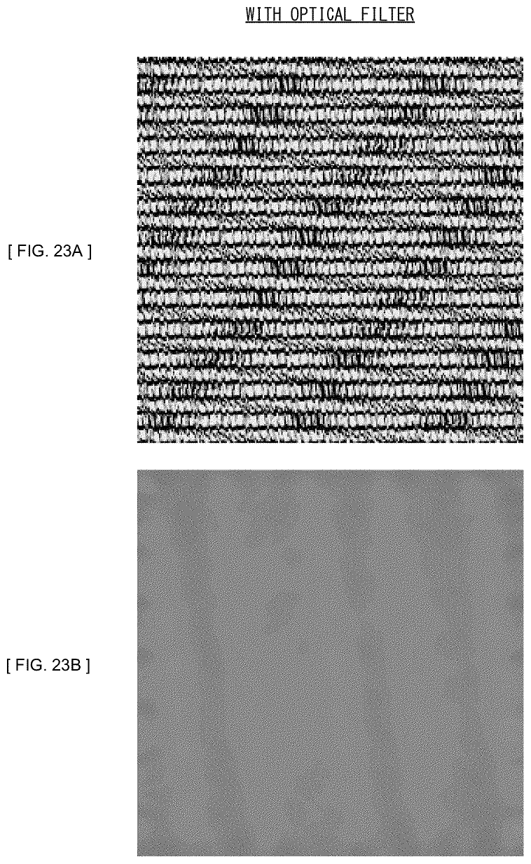

FIG. 22 is a simulation image illustrating an example of a state (A) of pixels and a state (B) of moiré that are observed in a case where the optical filter 4 is omitted from the stereoscopic display device according to the third specific example. FIG. 23 is a simulation image illustrating an example of a state (A) of pixels and a state (B) of moiré that are observed in the stereoscopic display device according to the third specific example.

As illustrated in FIG. 22 and FIG. 23, the optical filter 4 including the trapezoidal prism array 50 is disposed, which makes it possible to reduce the sizes of the dark sections that are a cause of moiré. This makes it possible to suppress crosstalk while reducing moiré.

### Fourth Specific Example

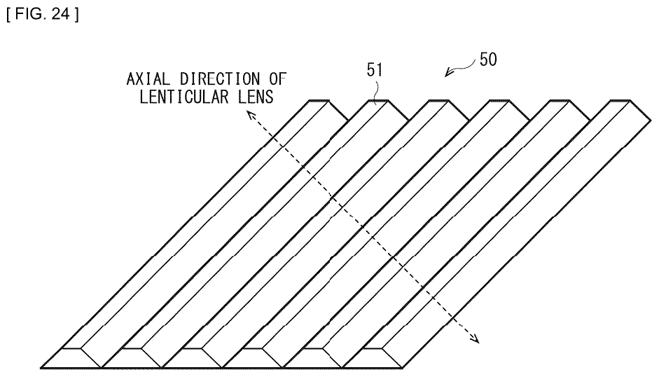

FIG. 24 is a configuration diagram schematically illustrating a configuration example of a trapezoidal prism array 50 serving as an optical filter 4 of a stereoscopic display device according to a fourth specific example.

In a way similar to the stereoscopic display device according to the third specific example (FIG. 19 to FIG. 21), the stereoscopic display device according to the fourth specific example includes the trapezoidal prism array 50 as the optical filter 4. In the third specific example, the stereoscopic display device is configured in such a manner that the plurality of trapezoidal prisms 51 is parallelly arrayed in the direction parallel to the array of the lenticular lens 3. However, in the fourth specific example, the stereoscopic display device is configured in such a manner that the plurality of trapezoidal prisms 51 is parallelly arrayed in the direction perpendicular to the array of the lenticular lens 3.

Here, detailed design values of the stereoscopic display device according to the fourth specific example will be listed.
Optimal observation distance D: 500 mm
Viewpoint angle θeye: 7.4 degrees
Lens pitch of lenticular lens 3: 0.143 mm
Array pitch (prism pitch) of trapezoidal prism array 50: 0.029 mm
Position of trapezoidal prism array 50: 6 mm from top surface of lenticular lens 3
Light beam control angle θh in horizontal direction: ±1 degree

The trapezoidal prism array 50 is designed in such a manner that the prism pitch of the trapezoidal prism array 50 is a value obtained by multiplying the subpixel pitch PL in the axial direction of the lenticular lens 3 by the following expression.
Ratio=1/(n+0.5), where n represents an integer.
The subpixel pitch PL in the axial direction of the lenticular lens 3 is represented as follows.
Horizontal subpixel size: Px
Inclination angle of lenticular lens 3: θL

$$PL = P x / sin θ L$$

When using the trapezoidal prism array 50 as the optical filter 4, it is possible to suppress crosstalk by accurately controlling the diffusion angle of the optical filter 4 and suppressing spreading of the angular distribution of light beams from the optical filter 4.

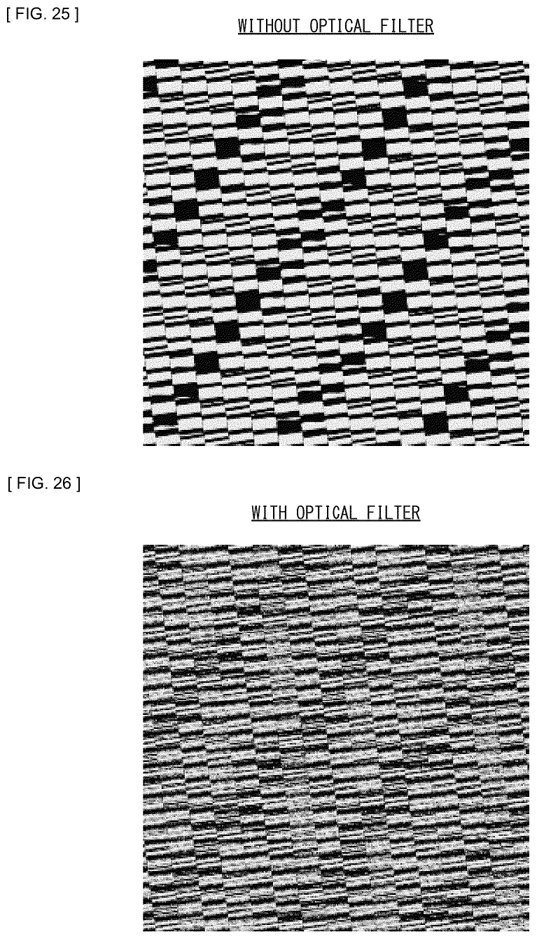

FIG. 25 is a simulation image illustrating an example of a state of pixels observed in a case where the optical filter 4 is omitted from the stereoscopic display device according to the fourth specific example. FIG. 26 is a simulation image illustrating an example of a state of pixels observed in the stereoscopic display device according to the fourth specific example.

As illustrated in FIG. 25 and FIG. 26, the optical filter 4 including the trapezoidal prism array 50 is disposed, which makes it possible to reduce the sizes of the dark sections that are a cause of moiré. This makes it possible to suppress crosstalk while reducing moiré.

### Fifth Specific Example

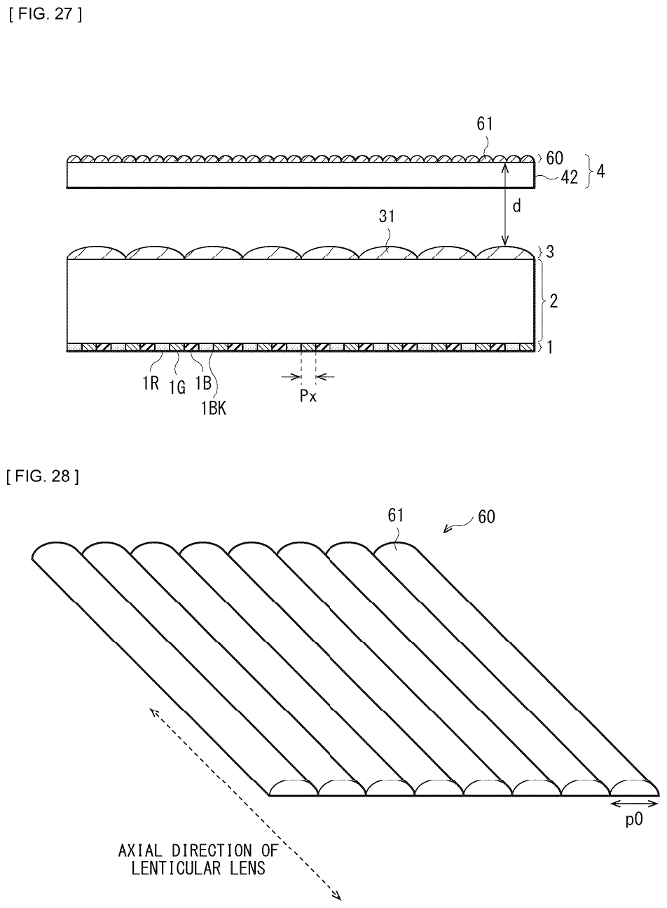

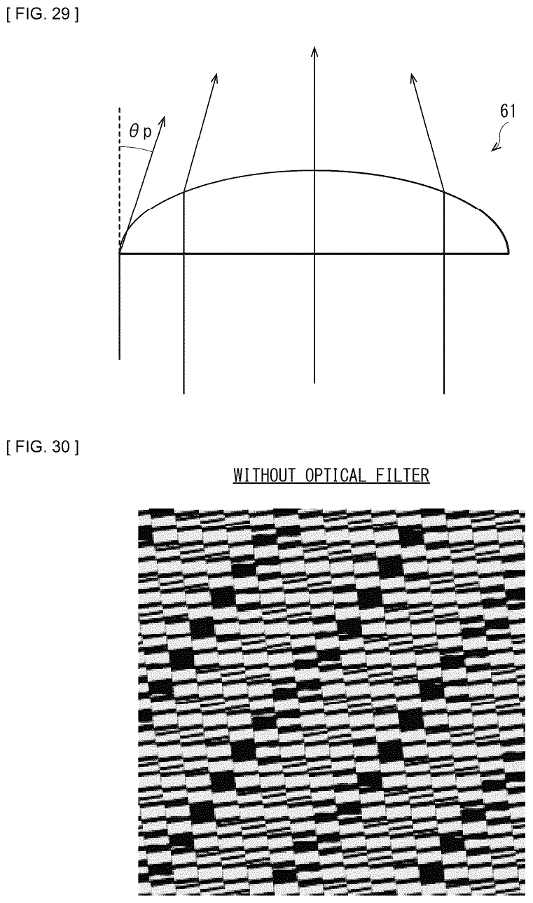

FIG. 27 is a cross-sectional diagram schematically illustrating a configuration example of a stereoscopic display device according to a fifth specific example in the horizontal direction. FIG. 28 is a configuration diagram schematically illustrating a configuration example of a lens array 60 serving as an optical filter 4 of the stereoscopic display device according to the fifth specific example. FIG. 29 is a cross-sectional diagram schematically illustrating the configuration example of the lens array 60 serving as the optical filter 4 of the stereoscopic display device according to the fifth specific example.

The stereoscopic display device according to the fifth specific example includes the lens array 60 as the optical filter 4. The lens array 60 is disposed on the top surface of the transparent substrate 42. The lens array 60 serving as the optical filter 4 may be integrated with the transparent substrate 42. The lens array 60 serving as the optical filter 4 includes a plurality of cylindrical lenses 61. The plurality of cylindrical lenses 61 is parallelly arrayed in a direction parallel to the array of the lenticular lens 3. A light beam control angle of the lens array 60 serving as the optical filter 4 is an angle decided on the basis of the plurality of viewpoint positions and a lens pitch (array pitch) of the lens array 60.

Here, detailed design values of the stereoscopic display device according to the fifth specific example will be listed.
Optimal observation distance D: 500 mm
Viewpoint angle θeye: 7.4 degrees
Lens pitch of lenticular lens 3: 0.143 mm
Lens pitch (array pitch) of optical filter 4 (lens array 60): 0.030 mm
Position of optical filter 4 (lens array 60): 2.75 mm from top surface of lenticular lens 3
Light beam control angle θh in horizontal direction: ±0.5 degrees
Focal length of optical filter 4 (lens array 60): 1.72 mm

The focal length of the lens array 60 serving as the optical filter 4 is designed in such a manner that a light beam at a pitch end has a predetermined output angle (see FIG. 29).
f: focal length
p0: lens pitch (array pitch) of optical filter 4 (lens array 60)
θp: output angle of light beam at pitch end

$$f = p 0 / 2 tan θ p$$

When using the lens array 60 as the optical filter 4, it is possible to suppress crosstalk by accurately controlling the diffusion angle of the optical filter 4 and suppressing spreading of the angular distribution of light beams from the optical filter 4.

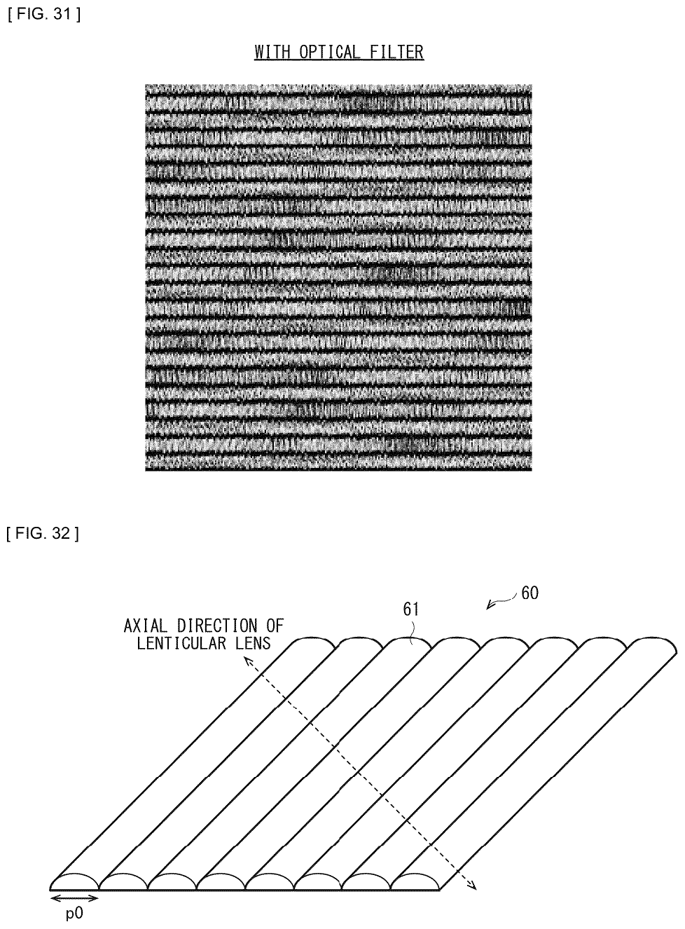

FIG. 30 is a simulation image illustrating an example of a state of pixels observed in a case where the optical filter 4 is omitted from the stereoscopic display device according to the fifth specific example. FIG. 31 is a simulation image illustrating an example of a state of pixels observed in the stereoscopic display device according to the fifth specific example.

As illustrated in FIG. 30 and FIG. 31, the optical filter 4 including the lens array 60 is disposed, which makes it possible to reduce the sizes of the dark sections that are a cause of moiré. This makes it possible to suppress crosstalk while reducing moiré.

### Sixth Specific Example

FIG. 32 is a configuration diagram schematically illustrating a configuration example of a lens array 60 serving as an optical filter 4 of a stereoscopic display device according to a sixth specific example.

In a way similar to the stereoscopic display device according to the fifth specific example (FIG. 27 to FIG. 29), the stereoscopic display device according to the sixth specific example includes the lens array 60 as the optical filter 4. In the fifth specific example, the stereoscopic display device is configured in such a manner that the plurality of cylindrical lenses 61 is parallelly arrayed in the direction parallel to the array of the lenticular lens 3. However, in the sixth specific example, the stereoscopic display device is configured in such a manner that the plurality of cylindrical lenses 61 is parallelly arrayed in the direction perpendicular to the array of the lenticular lens 3.

Here, detailed design values of the stereoscopic display device according to the sixth specific example will be listed.
Optimal observation distance D: 500 mm
Viewpoint angle θeye: 7.4 degrees
Lens pitch of lenticular lens 3: 0.143 mm
Lens pitch (array pitch) of optical filter 4 (lens array 60): 0.029 mm
Position of optical filter 4 (lens array 60): 6 mm from top surface of lenticular lens 3
Light beam control angle θh in horizontal direction: ±1.0 degree
Focal length of optical filter 4 (lens array 60): 0.83 mm

In a way similar to the stereoscopic display device according to the fifth specific example, the focal length of the lens array 60 serving as the optical filter 4 is designed in such a manner that a light beam at a pitch end has a predetermined output angle (see FIG. 29).

When using the lens array 60 as the optical filter 4, it is possible to suppress crosstalk by accurately controlling the diffusion angle of the optical filter 4 and suppressing spreading of the angular distribution of light beams from the optical filter 4.

### Seventh Specific Example

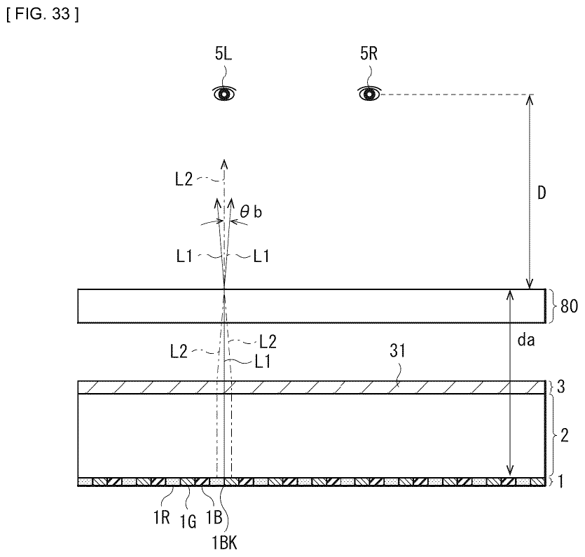

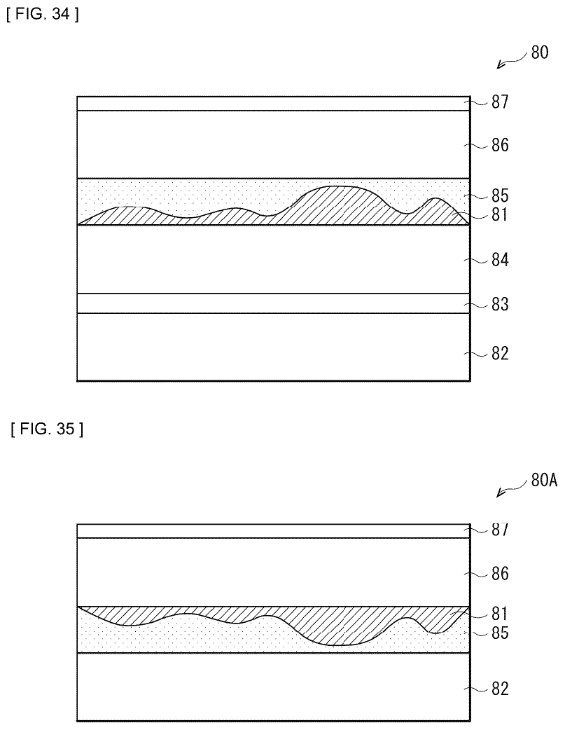

FIG. 33 is a cross-sectional diagram schematically illustrating a configuration example of a stereoscopic display device according to a seventh embodiment in an axial direction of a lenticular lens 3. FIG. 34 is a cross-sectional diagram schematically illustrating a configuration example of an optical filter 80 of the stereoscopic display device according to the seventh specific example. FIG. 35 is a cross-sectional diagram schematically illustrating a modification of the optical filter 80 of the stereoscopic display device according to the seventh specific example.

The optical filter 80 according to the stereoscopic display device according to the seventh specific example includes an optical filter layer 81, a glass base material 82, an optically-clear adhesive (OCA) (optical adhesive sheet) 83, a base material film 84, a low refractive index layer 85, a base material film 86, an antireflective (AR) layer 87.

The optical filter layer 81 has a top surface with a substantially-triangular-prism-shaped recessed and projected structure.

It is to be noted that, as exemplified in the modification in FIG. 35, the optical filter layer 81 may have a bottom surface with the substantially-triangular-prism-shaped recessed and projected structure. An optical filter 80A according to the modification in FIG. 35 includes an optical filter layer 81, a glass base material 82, a low refractive index layer 85, a base material film 86, and an AR layer 87.

In a case of suppressing a diffusion angle of the optical filter 80 to a small angle, it is necessary for the optical filter layer 81 to have recesses and projections with small inclination angles. In this case, sometimes the pitch of the recesses and projections may be substantially more than or equal to the lens pitch of the lenticular lens 3 if increasing the pitch of the recesses and projections. This causes harmful effects such as color unevenness or glare.

When reducing the pitch of the recesses and projections of the optical filter layer 81, the recesses and projections have very short heights, and this exceeds a manufacturable level. In this case, it is possible to increase the inclination angles of the recesses and projections by burying the recesses and projections in a layer having a different refractive index. In other words, it is possible to control the angles in such a manner that the angles fall within a predetermined angular range by burying recesses and projections of a diffuser plate (prism) having a large diffusion angle, in resin or the like having a different refractive index. The stereoscopic display device according to the seventh specific example is configured in such a manner that the optical filter layer 81 is buried in the low refractive index layer 85 having a lower refractive index than a refractive index of the optical filter layer 81. The refractive index of the optical filter layer 81 and the refractive index of the low refractive index layer 85 are desirably designed to be the following values, for example.
Refractive index of low refractive index layer 85: 1.41 (silicone OCA)
Refractive index of optical filter layer 81: 1.5

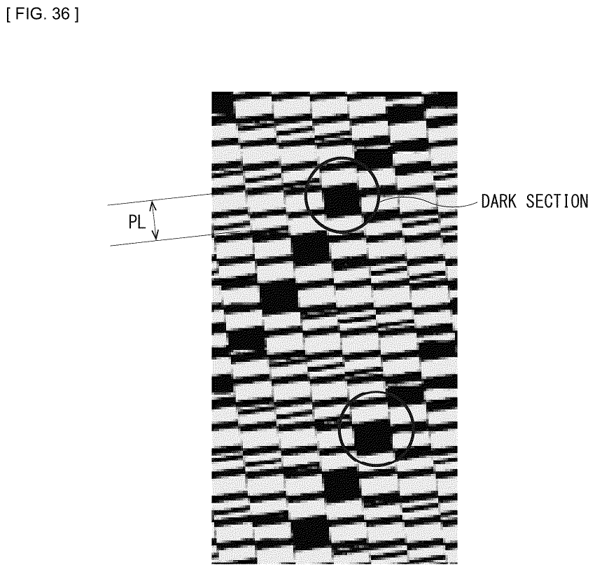

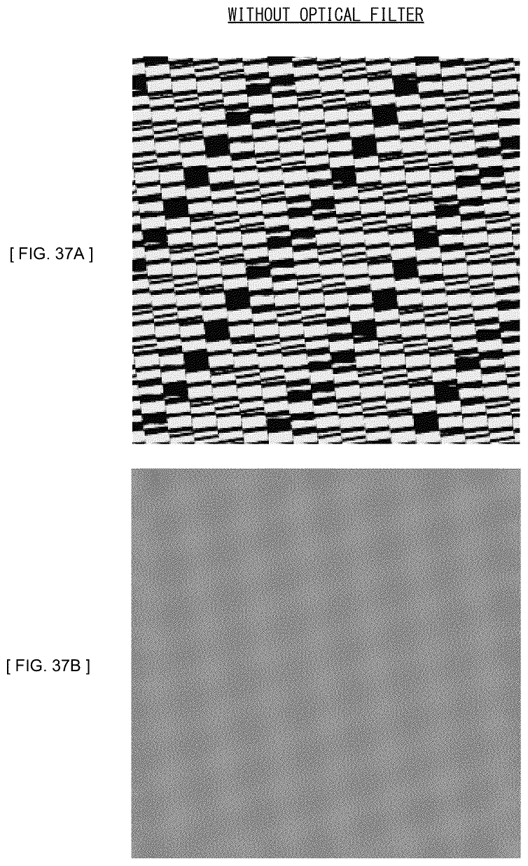

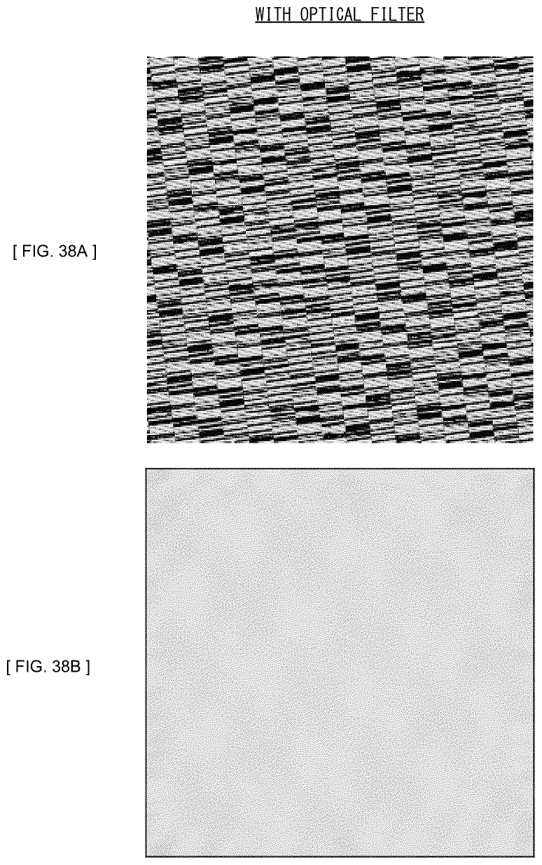

FIG. 36 is a simulation image illustrating an example of a state of pixels observed via the lenticular lens 3 in a case where the optical filter 80 is omitted from the stereoscopic display device according to the seventh specific example. FIG. 37 is a simulation image illustrating an example of a state (A) of pixels and a state (B) of moiré that are observed in the case where the optical filter 80 is omitted from the stereoscopic display device according to the seventh specific example. FIG. 38 is a simulation image illustrating an example of a state (A) of pixels and a state (B) of moiré that are observed in the stereoscopic display device according to the seventh specific example.

In the seventh specific example, the optical filter 80 mixes light beams L1 and L2 from two positions decided by the distance d (see FIG. 33) between the top surface of the optical filter 80 and the top surface of the image display element 1 (pixel surface considering refractive index) and the light beam control angle θb of the optical filter 80 in the axial direction of lenticular lens 3.

The dark section (see FIG. 36) that is a cause of moiré appears, for example, on a 4-subpixel cycle in a case where the optical filter 80 is not used. When the optical filter layer 81 is designed to have an angle of refraction that is same as the subpixel pitch PL in the axial direction of the lenticular lens 3, the cycle of the dark section becomes a 2-subpixel cycle, contrast decreases, and this reduces moiré.

As illustrated in FIG. 37 and FIG. 38, the optical filter 80 including the optical filter layer 81 with the substantially-triangular-prism-shaped recessed and projected structure is disposed, which makes it possible to reduce the sizes of the dark sections that are a cause of moiré. This makes it possible to suppress crosstalk while reducing moiré.

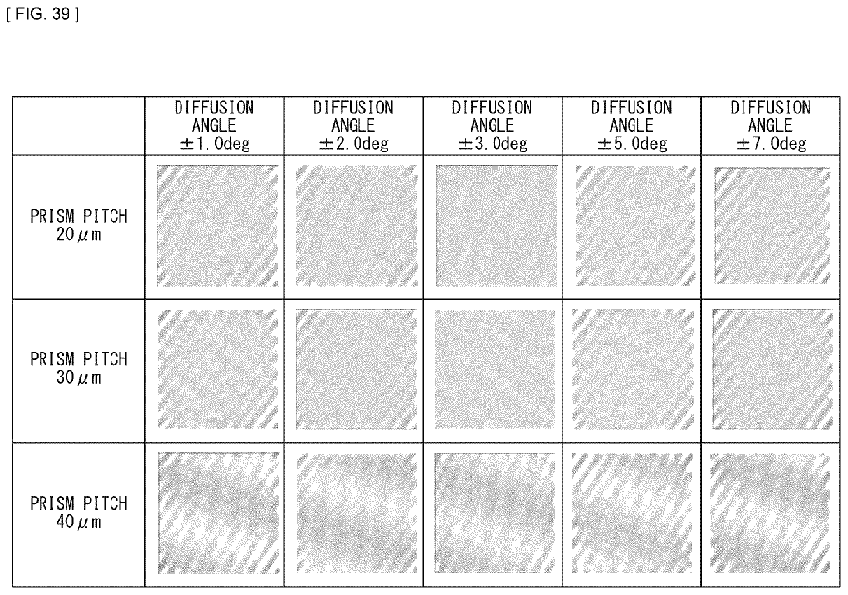

FIG. 39 is an explanatory diagram illustrating a relation among an array pitch (prism pitch) of the optical filter 80 in the axial direction of the lenticular lens 3, a diffusion angle (light beam control angle θb) of the optical filter 80 in the axial direction of the lenticular lens 3, and moiré, with regard to the stereoscopic display device according to the seventh specific example. It is to be noted that, the prism pitch described herein means pitch of the substantially-triangular-prism-shaped recessed and projected structure of the optical filter layer 81 of the optical filter 80.

As illustrated in FIG. 39, a moiré occurrence state varies depending on the relation between the diffusion angle and the prism pitch of the optical filter layer 81 of the optical filter 80.

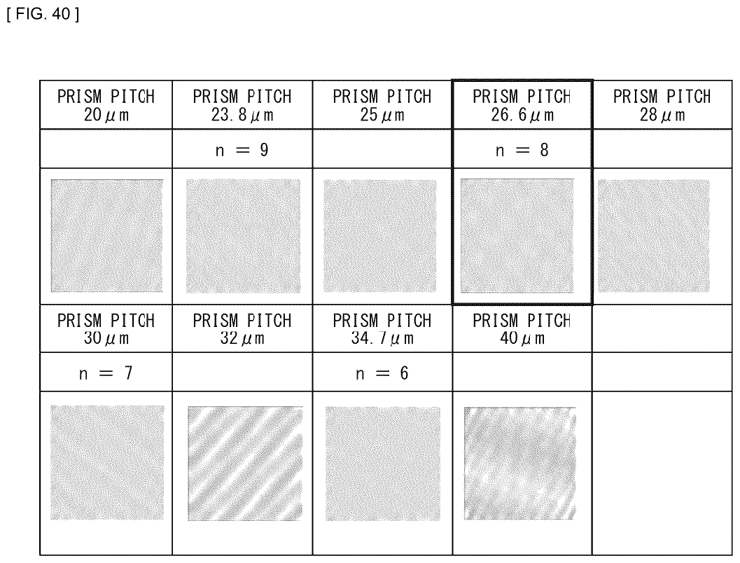

FIG. 40 is an explanatory diagram illustrating a relation among a prism pitch of the optical filter 80 in the axial direction of the lenticular lens 3, an optimal condition for the prism pitch of the optical filter 80, and moiré, with regard to the stereoscopic display device according to the seventh specific example. FIG. 40 illustrates a case where the diffusion angle of the optical filter 80 in the axial direction of the lenticular lens 3 is 3.5 degrees. It is to be noted that, the prism pitch described herein means pitch of the substantially-triangular-prism-shaped recessed and projected structure of the optical filter layer 81. In addition, the optimal condition for the prism pitch is represented by the following expression.

PL/(n+0.5), where n represents an integer
PL: Subpixel pitch in axial direction of lenticular lens 3

As illustrated in FIG. 40, moiré degrade more in a case where the prism pitch is 30 μm or more and deviates from the optimal condition. In a case where n=9, colored moiré slightly shows up. In a case where n=8 and the prism pitch is 26.6 μm, moiré occurs less.

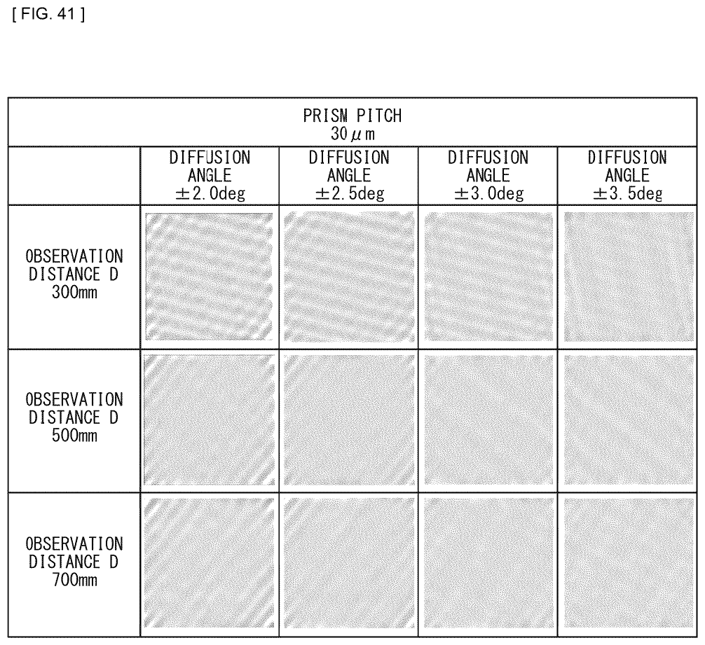

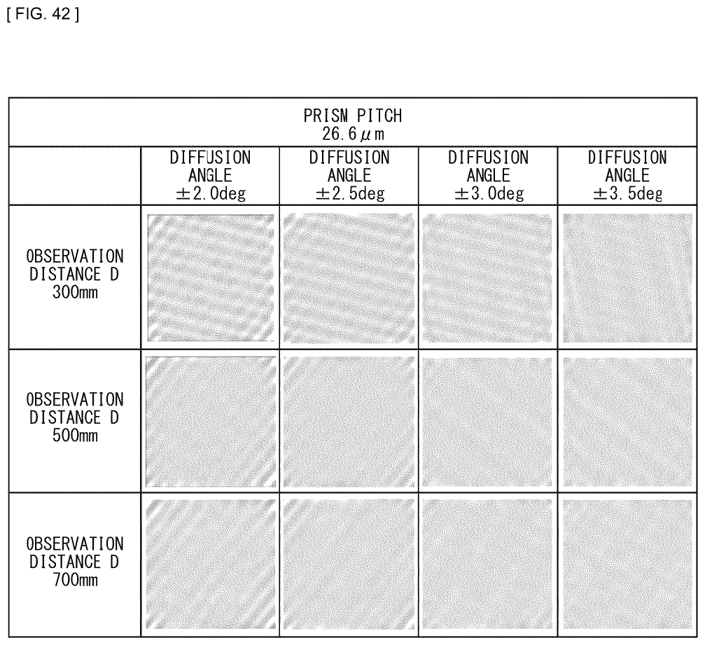

FIG. 41 is an explanatory diagram illustrating a relation among an observation distance D, a diffusion angle of the optical filter 80 in the axial direction of the lenticular lens 3, and moiré, the relation being obtained in a case where the prism pitch of the optical filter 80 is 30 μm with regard to the stereoscopic display device according to the seventh specific example. FIG. 42 is an explanatory diagram illustrating a relation among an observation distance D, a diffusion angle of the optical filter 80 in the axial direction of the lenticular lens 3, and moiré, the relation being obtained in a case where the prism pitch of the optical filter 80 is 26.6 μm with regard to the stereoscopic display device according to the seventh specific example.

As illustrated in FIG. 42, a moiré occurrence state varies depending on the relation between the observation distance D and the diffusion angle.

### Eighth Specific Example

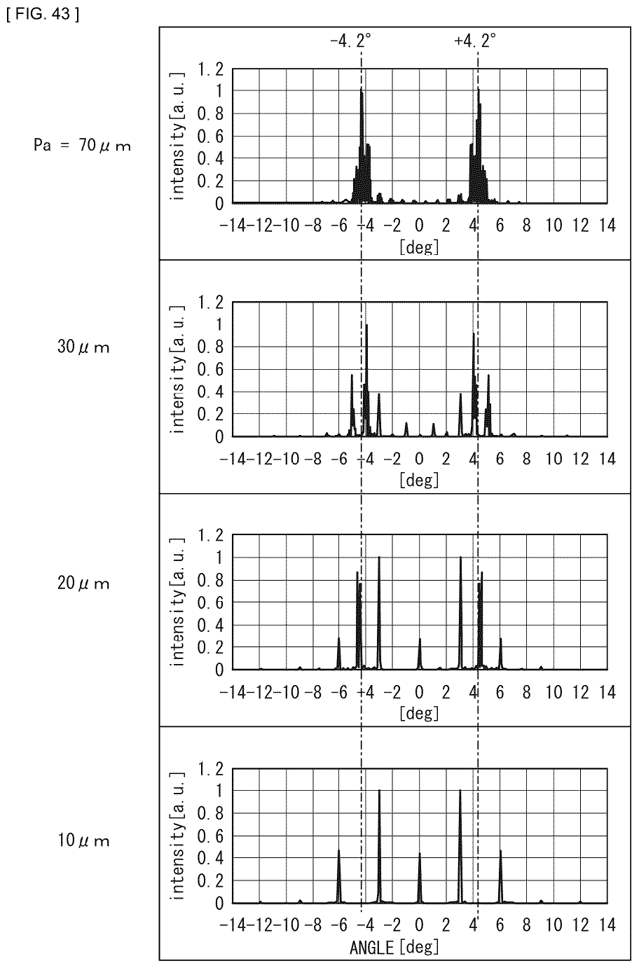

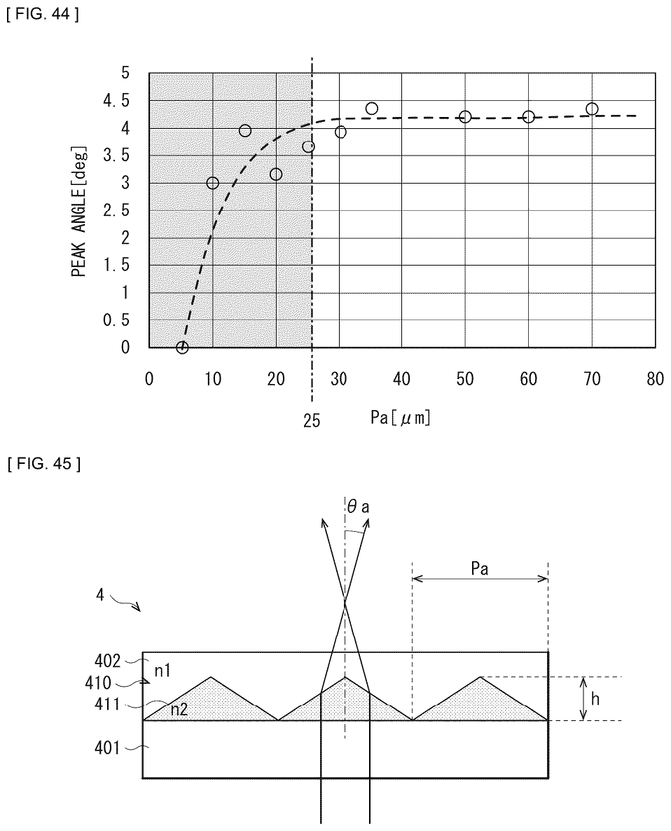

FIG. 43 and FIG. 44 illustrate influence of diffraction caused by narrowing array pitch Pa of the optical filter 4.

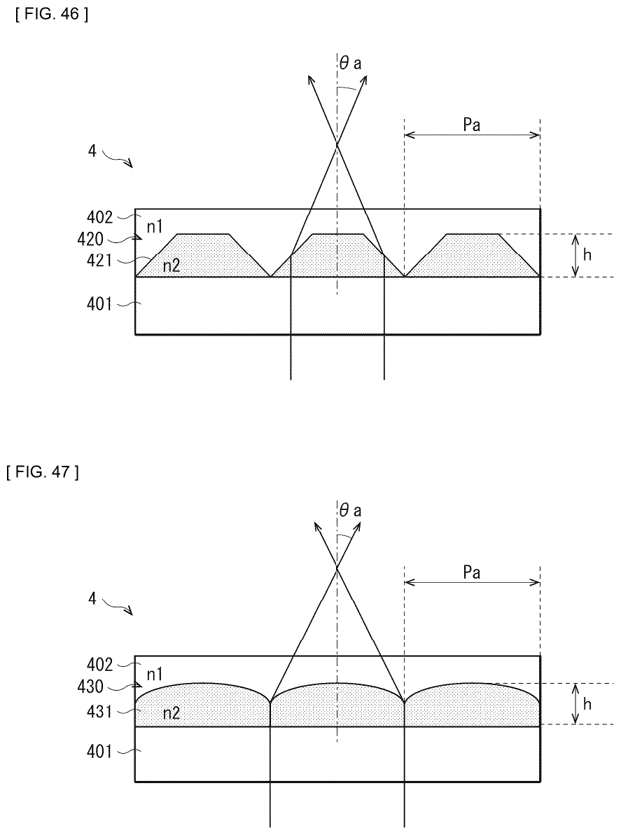

In addition, FIG. 45 illustrates a configuration example of an optical filter 4 using a triangle prism array 410. FIG. 46 illustrates a configuration example of an optical filter 4 using a trapezoidal prism array 420. FIG. 47 illustrates a configuration example of an optical filter 4 using a lens array 430.

The optical filter 4 may include a prism array including a plurality of prisms, as the optical filter layer. For example, as illustrated in FIG. 45, the optical filter 4 may include the triangle prism array 410 in which a plurality of triangle prisms 411 is parallelly arrayed, as the optical filter layer. The triangle prism array 410 may be disposed on the transparent substrate 401. A low refractive index layer 402 may be stacked on the triangle prism array 410. The low refractive index layer 402 may be an air layer.

In addition, for example, as illustrated in FIG. 46, the optical filter 4 may include the trapezoidal prism array 420 in which a plurality of trapezoidal prisms 421 is parallelly arrayed, as the optical filter layer. The trapezoidal prism array 420 may be disposed on the transparent substrate 401. A low refractive index layer 402 may be stacked on the trapezoidal prism array 420. The low refractive index layer 402 may be the air layer.

In addition, for example, as illustrated in FIG. 47, the optical filter 4 may include the lens array (lenticular lens) 430 in which a plurality of cylindrical lenses 431 is parallelly arrayed, as the optical filter layer. The lens array 430 may be disposed on the transparent substrate 401. A low refractive index layer 402 may be stacked on the lens array 430. The low refractive index layer 402 may be the air layer.

FIG. 43 and FIG. 44 illustrate angular distributions of light beams output from the optical filters 4 in a case where the optical filter layer is the triangle prism array 410 (FIG. 45). In FIG. 43, horizontal axes represent output light beam angles, and vertical axes represent light intensity. In addition, FIG. 43 illustrates respective angular distributions obtained in cases where the array pitch Pa of the triangle prism array 410 is set to 10 μm, 20 μm, 30 μm, and 70 μm. In FIG. 44, a horizontal axis represents the array pitch Pa, and a vertical axis represents angle (peak angle) of an output light beam with maximum light intensity.

In general, when the image display element 1 has a smaller pixel size, the lenticular lens 3 has a narrower pitch and the optical filter 4 also has a narrower array pitch Pa. When the optical filter 4 has the narrower array pitch Pa, influence of diffraction becomes dominant, and this makes it difficult to obtain an appropriate light beam control angle θa. FIG. 43 and FIG. 44 illustrate angular distributions of output light beams obtained in a case where a dominant wavelength of light beams that enter the optical filter 4 is set to 530 nm and the triangle prisms 411 are designed to have an angle of refraction in such a manner that the optical filter 4 has a light beam control angle θa of 4.2 degrees. In addition, as illustrated in FIG. 45, the light beam control angle θa is set to an angle in a cross-section in an array direction of the plurality of triangle prisms 411.

As can be understood from FIG. 43 and FIG. 44, when the array pitch Pa gets narrowed and becomes about 25 μm or less (Pa≤25 μm), the angle of output light beam deviates from the angle of refraction by the triangle prism 411 due to the influence of diffraction, and this makes it difficult to obtain an anticipated light beam control angle θa.

Therefore, when Pa≤25 μm holds true, it is preferable to design the light beam control angle θa not on the basis of the angle of refraction but in consideration of the influence of diffraction. Specifically, when Pa≤25 μm holds true, a configuration may be adopted in which the following conditional expressions (1) and (2) with regard to the light beam control angle θa of the optical filter 4 are satisfied.

$$θ a = {sin}^{- 1} ( m λ / Pa ) \qquad ( 1 )$$

$$0.9 m π \leq δ \leq 0.9 ( m + 1 ) π \qquad ( 2 )$$

where m represents a diffraction order number (integer) of diffracted light caused by the prism array (or lens array),
λ represents a dominant wavelength that enters the optical filter 4, and
δ represents a phase difference caused by passing of a light beam having entered the optical filter 4 through the prism array (or lens array).

Here, the phase difference δ is represented as follows.

$$δ = Δ nh \cdot 2 π / λ$$

where h represents a height of the optical filter layer (prism array or lens array) (see FIG. 45 to FIG. 47), and Δn represents a refractive index difference (=|n2−n1|) between a refractive index n2 of the optical filter layer and a refractive index n1 of a layer (low refractive index layer 402) that is adjacent to the optical filer layer.

When selecting the diffraction order m and the phase difference δ that satisfy the conditional expressions (1) and (2), it is possible to accurately control the light beam control angle θa and obtain an angular distribution with no lasting effect (to suppress spreading of the angular distribution due to the influence of diffraction) even in a case where the array pitch Pa of the optical filter 4 satisfies Pa≤25 μm.

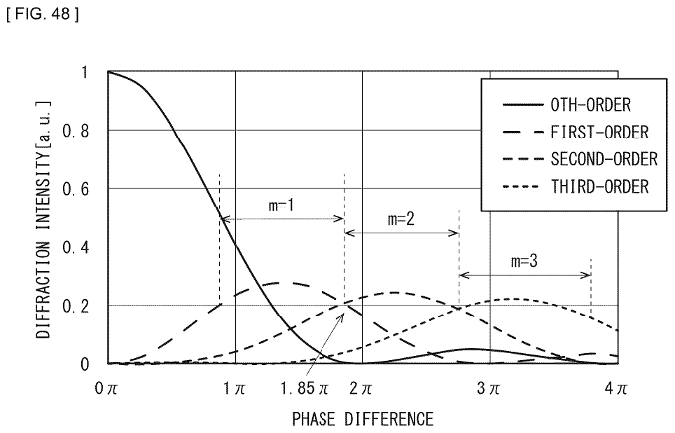

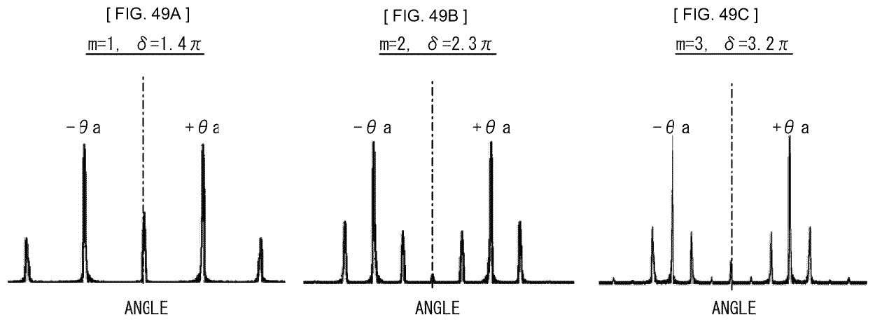

FIG. 48 illustrates an example of a relation between the phase difference δ and diffraction intensity of the optical filter 4. In FIG. 48, a horizontal axis represents the phase difference δ, and a vertical axis represents the diffraction intensity. FIG. 48 illustrates the phase difference δ (Δnh·2π/λ) and quantities of diffracted light of respective diffraction orders m that are obtained in a case of using the triangle prism array 410 in which triangular prisms 411 having substantially triangular shapes are parallelly arrayed, as the optical filter layer. In a similar way, FIG. 49 illustrates an example of an angular distribution of light beams output from the optical filter 4 in the case of using the triangle prism array 410 in which the triangular prisms 411 having substantially triangular shapes are parallelly arrayed, as the optical filter layer. In FIG. 49, horizontal axes represent output light beam angles, and vertical axes represent light intensity.

For example, in a case where Pa≤25 μm and m=1 (diffraction order is 1), the light beam control angle θa is calculated from the expression (1) while using first-order diffracted light as a basic angle. In the example illustrated in FIG. 48, the angular distribution illustrated in (A) of FIG. 49 is obtained while using the first-order diffracted light as the basic angle, when the refractive index difference Δn and the height h of the optical filter layer are decided in such a manner that the phase difference δ=Δnh·2π/λ is calculated to be 0.9π to 1.8π, on the basis of the expression (2). (A) of FIG. 49 illustrates the angular distribution obtained in a case where m=1 and δ=1.4π.

In a case where m=2 (diffraction order is 2), the light beam control angle θa is calculated from the expression (1) while using second-order diffracted light as the basic angle. In the example illustrated in FIG. 48, an angular distribution illustrated in (B) of FIG. 49 is obtained while using the second-order diffracted light as the basic angle, when the refractive index difference Δn and the height h of the optical filter layer are decided in such a manner that the phase difference δ=Δnh·2π/λ is calculated to be 1.8π to 2.7π, on the basis of the expression (2). (B) of FIG. 49 illustrates the angular distribution obtained in a case where m=2 and δ=2.3.

In a case where m=3 (diffraction order is 3), the light beam control angle θa is calculated from the expression (1) while using third-order diffracted light as the basic angle, and an angular distribution like (C) of FIG. 49 is obtained while using third-order diffracted light as the basic angle. (C) of FIG. 49 illustrates the angular distribution obtained in a case where m=3 and δ=3.2×.

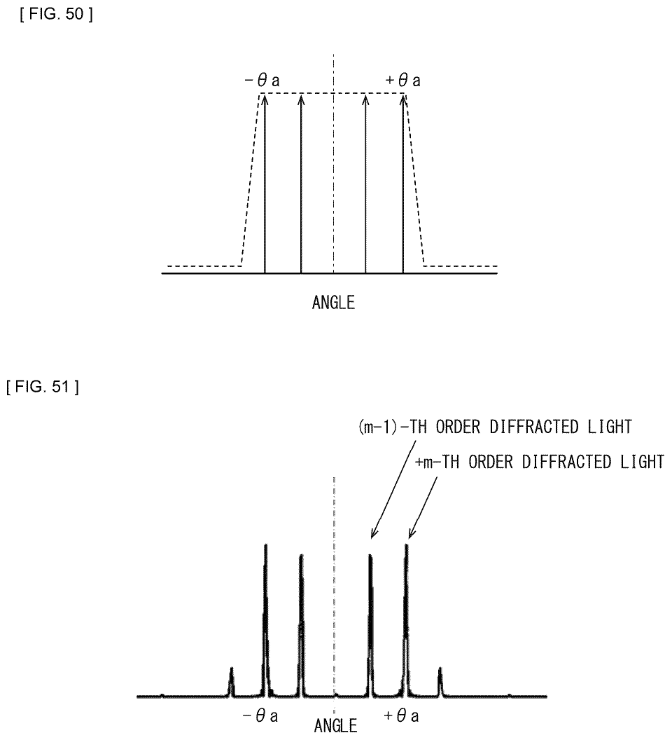

FIG. 50 illustrates an example of an angular distribution of light beams output from the optical filter 4. When diffusive light beams are controlled to a range of a light beam control angle±θa as illustrated in FIG. 50, the optical filter 4 may output a plurality of light beams, and it is possible to improve a moiré reduction effect by approximating the angular distribution to a trapezoidal distribution (top hat distribution) having a top base that is the light beam control angle±θa.

FIG. 51 illustrates an example of an angular distribution of light beams output from the optical filter 4. When selecting a phase difference δ that allows intensity of m-th order diffracted light to be substantially equal to intensity of (m−1)-th order diffracted light with regard to the conditional expressions (1) and (2), it is possible to generate±m-th order diffracted light and ±(m−1)-th order diffracted light that have similar intensities within the light beam control angle±θa, and it is possible to further improve the moiré reduction effect without worsening the crosstalk. For example, when selecting m=2 and the phase difference δ=1.85π (see FIG. 48), the second-order diffracted light has similar intensity as intensity of the first-order diffracted light, and this makes it possible to obtain the angular distribution like FIG. 51.

### Eighth Specific Example: Design Example of Trapezoidal Prism Array 420

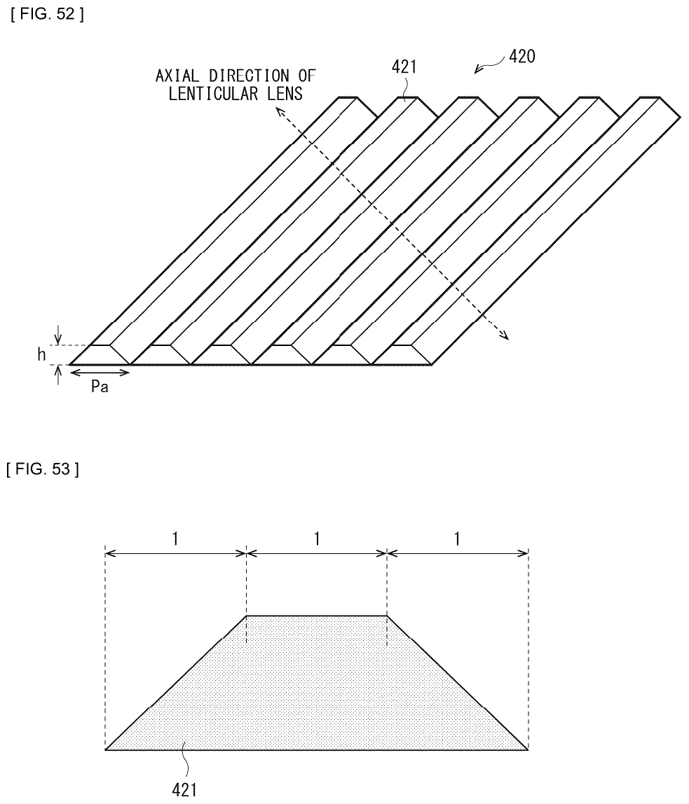

FIG. 52 schematically illustrates a configuration example of a trapezoidal prism array 420 used as an optical filter 4 of a stereoscopic display device according to an eighth specific example. FIG. 53 schematically illustrates a configuration example of a trapezoidal prism 421.

In this design example, as illustrated in FIG. 52, the trapezoidal prism array 420 is configured in such a manner that the plurality of trapezoidal prisms 421 is parallelly arrayed in a direction perpendicular to the array of the lenticular lens 3. In addition, in this design example, the trapezoidal prisms 421 are configured in such a manner that inclined sections in right and left of the trapezoid have a ratio of 1/3 in the horizontal direction in a cross-section in the horizontal direction as illustrated in FIG. 53. It is to be noted that the plurality of trapezoidal prisms 421 may be parallelly arrayed in a direction parallel to the array of the lenticular lens 3.

Here, detailed design values of the stereoscopic display device will be listed. It is to be noted that a low refractive index layer 402 is stacked on the trapezoidal prism array 420 in a way similar to the configuration example illustrated in FIG. 46. As illustrated in FIG. 46, the light beam control angle θa is set to an angle in a cross-section in an array direction of the plurality of trapezoidal prisms 421.
Optimal observation distance D: 500 mm
Lens pitch of lenticular lens 3: 0.143 mm
Refractive index n1 of low refractive index layer 402: 1.41
Refractive index (prism refractive index) n2 of optical filter layer: 1.52
Height (prism height) h of optical filter layer: 2.9 μm
Array pitch (prism pitch) Pa of trapezoidal prism array 420: 15.2 μm
Position of trapezoidal prism array 420: 2.75 mm from top surface of lenticular lens 3
Design dominant wavelength λ: 0.53 μm
Diffraction order m: 1
Phase difference δ=Δnh·2π/λ: 1.2×
Light beam control angle θa: ±2 degrees

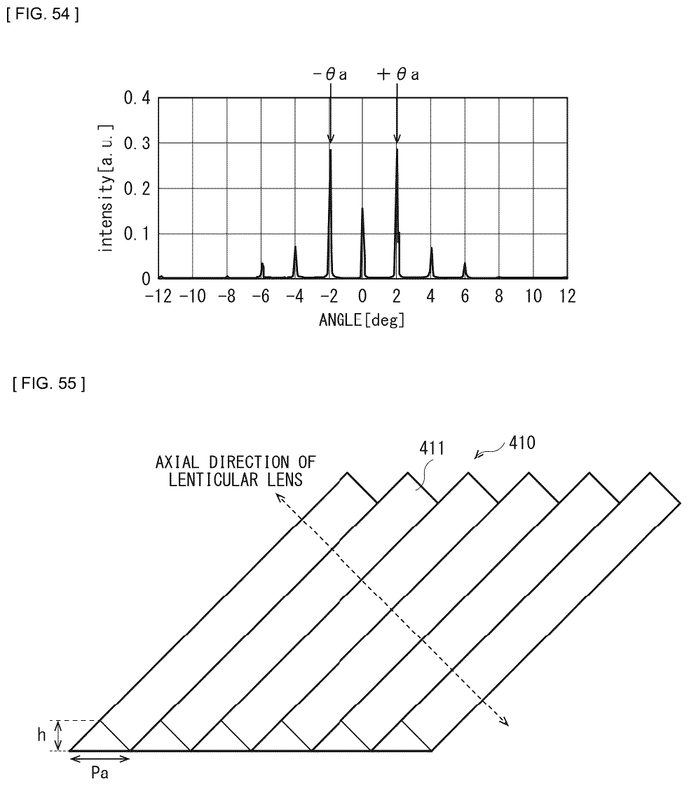

FIG. 54 illustrates an example of an angular distribution of light beams output from an optical filter 4 in a case where a trapezoidal prism array 420 is used as the optical filter 4. In this design example, as can be understood from FIG. 54, it is possible to accurately control angles of output light beams and obtain an angular distribution with no lasting effect even in a case where the array pitch Pa satisfies Pa≤25 μm

### Eighth Specific Example: Design Example of Triangle Prism Array 410

FIG. 55 schematically illustrates a configuration example of a triangle prism array 410 used as the optical filter 4 of the stereoscopic display device according to the eighth specific example.

In this design example, as illustrated in FIG. 55, the triangle prism array 410 is configured in such a manner that the plurality of triangle prisms 411 is parallelly arrayed in a direction perpendicular to the array of the lenticular lens 3. It is to be noted that the plurality of triangle prisms 411 may be parallelly arrayed in a direction parallel to the array of the lenticular lens 3.

Here, detailed design values of the stereoscopic display device will be listed. It is to be noted that a low refractive index layer 402 is stacked on the triangle prism array 410 in a way similar to the configuration example illustrated in FIG. 45. As illustrated in FIG. 45, the light beam control angle θa is set to an angle in a cross-section in an array direction of the plurality of triangle prisms 411.
Optimal observation distance D: 500 mm
Lens pitch of lenticular lens 3: 0.238 mm
Refractive index n1 of low refractive index layer 402: 1.41
Refractive index (prism refractive index) n2 of optical filter layer: 1.52
Height (prism height) h of optical filter layer: 4.5 μm
Array pitch (prism pitch) Pa of triangle prism array 410: 17.4 μm
Position of triangle prism array 410: 0.85 mm from top surface of lenticular lens 3
Design dominant wavelength λ: 0.53 μm
Diffraction order m: 2
Phase difference δ=Δnh·2π/λ: 1.85π
Light beam control angle θa: ±3.5 degrees

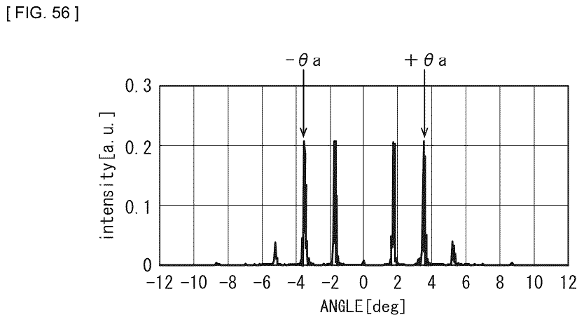

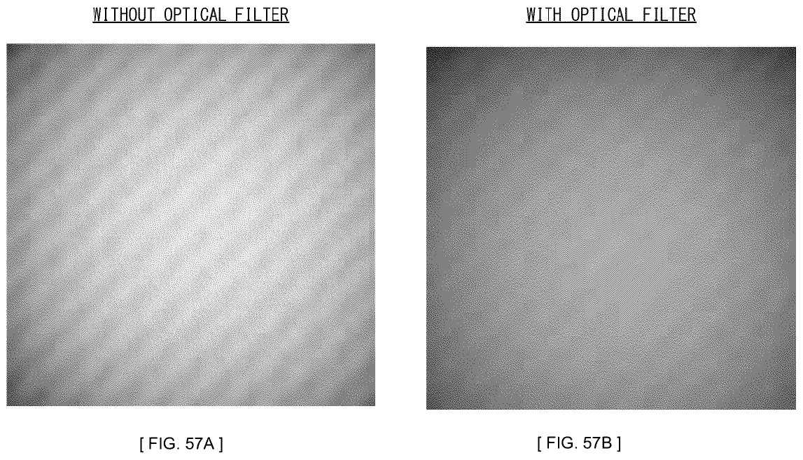

FIG. 56 illustrates an example of an angular distribution of light beams output from an optical filter 4 in a case where the triangle prism array 410 is used as the optical filter 4. In addition, FIG. 57 illustrates an example of simulation images of a state of moiré observed in a case where the stereoscopic display device according to the eighth specific example includes no optical filter 4, and a state of moiré observed in a case where the stereoscopic display device according to the eighth specific example includes the optical filter 4.

In this design example, as can be understood from FIG. 56, it is possible to accurately control angles of output light beams and obtain an angular distribution with no lasting effect even in a case where the array pitch Pa of the optical filter 4 satisfies Pa≤25 μm. In addition, in this design example, the phase difference δ is selected in such a manner that intensity of +second-order diffracted light substantially matches intensity of +first-order diffracted light as illustrated in FIG. 56. This makes it possible to generate a plurality of light beams as the output light beams within the light beam control angle±3.5 degrees, and it is possible to further improve the moiré reduction effect without worsening the crosstalk as illustrated in FIG. 57.

### Eighth Specific Example: Design Example of Lens Array 430

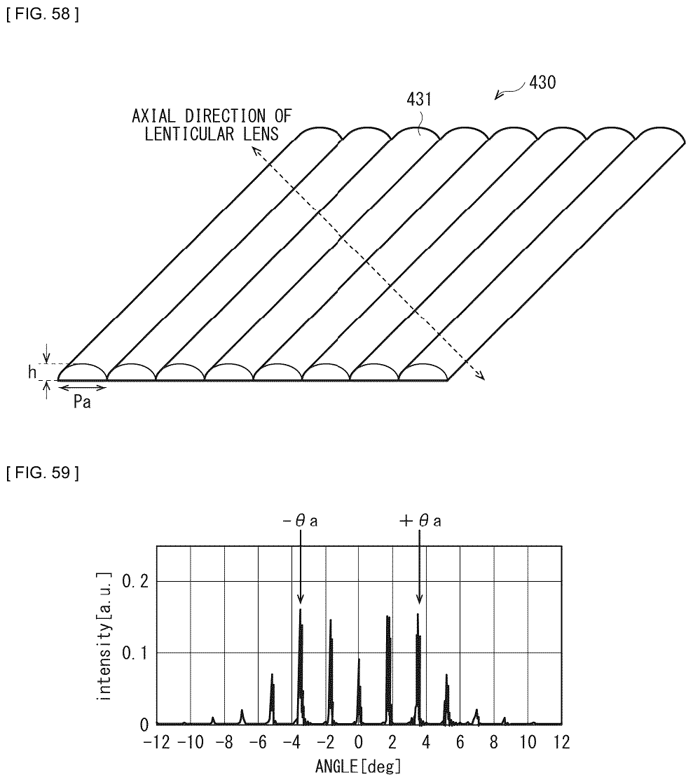

FIG. 58 schematically illustrates a configuration example of a lens array 430 used as the optical filter 4 of the stereoscopic display device according to the eighth specific example.

In this design example, as illustrated in FIG. 58, the lens array 430 is configured in such a manner that the plurality of cylindrical lenses 431 is parallelly arrayed in a direction perpendicular to the array of the lenticular lens 3. It is to be noted that the plurality of cylindrical lenses 431 may be parallelly arrayed in a direction parallel to the array of the lenticular lens 3.

Here, detailed design values of the stereoscopic display device will be listed. It is to be noted that a low refractive index layer 402 is stacked on the lens array 430 in a way similar to the configuration example illustrated in FIG. 47. As illustrated in FIG. 47, the light beam control angle θa is set to an angle in a cross-section in an array direction of the plurality of cylindrical lenses 431.
Optimal observation distance D: 500 mm
Lens pitch of lenticular lens 3: 0.238 mm
Refractive index n1 of low refractive index layer 402: 1.41
Refractive index (lens refractive index) n2 of optical filter layer: 1.52
Height (lens height) h of optical filter layer: 4.8 μm
Array pitch (lens pitch) Pa of lens array 430: 17.4 μm
Position of lens array 430: 0.85 mm from top surface of lenticular lens 3
Design dominant wavelength λ: 0.53 μm
Diffraction order m: 2
Phase difference δ=Δnh·2π/λ: 2×
Light beam control angle θa: ±3.5 degrees

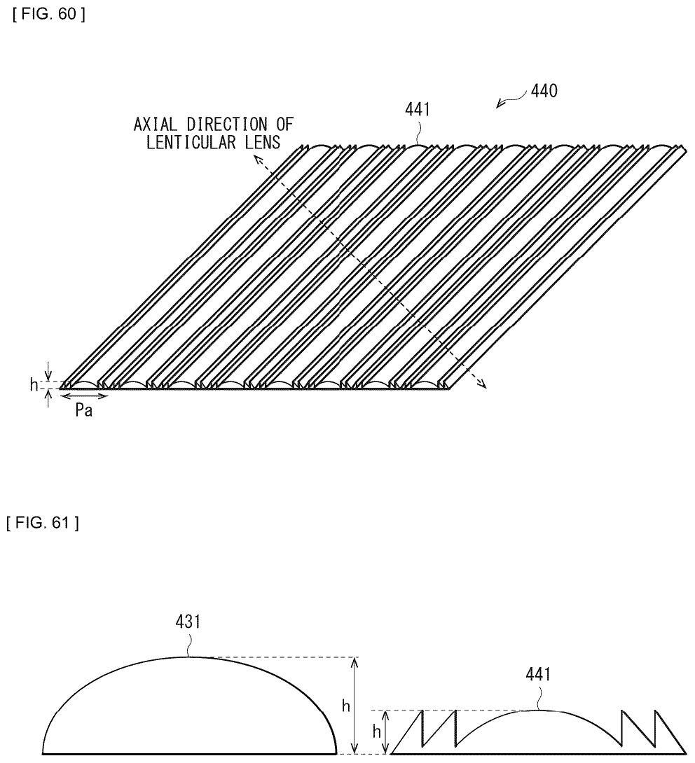

FIG. 59 illustrates an example of an angular distribution of light beams output from an optical filter 4 in a case where the lens array 430 is used as the optical filter 4. As can be understood from FIG. 59, it is possible to accurately control angles of output light beams and obtain an angular distribution with no lasting effect even in a case where the array pitch Pa of the optical filter 4 satisfies Pa≤25 μm. In addition, in this design example, the phase difference δ is selected in such a manner that intensity of +second-order diffracted light matches intensity of +first-order diffracted light. This makes it possible to generate a plurality of light beams as the output light beams within the light beam control angle±3.5 degrees, and it is possible to further improve the moiré reduction effect without worsening the crosstalk.

### Ninth Specific Example

FIG. 60 schematically illustrates a configuration example of a lens array 440 used as an optical filter 4 of a stereoscopic display device according to a ninth specific example.

The optical filter 4 may include the lens array 440 in which a plurality of blazed cylindrical lenses 441 is parallelly arrayed, as the optical filter layer. In the configuration example illustrated in FIG. 60, the lens array 440 is configured in such a manner that the plurality of blazed cylindrical lenses 441 is parallelly arrayed in a direction perpendicular to the array of the lenticular lens 3. It is to be noted that the plurality of cylindrical lenses 441 may be parallelly arrayed in a direction parallel to the array of the lenticular lens 3.

Here, detailed design values of the stereoscopic display device according to the ninth specific example will be listed. It is to be noted that a low refractive index layer 402 is stacked on the lens array 440 in a way similar to the configuration example illustrated in FIG. 47. The light beam control angle θa is set to an angle in a cross-section in an array direction of the plurality of cylindrical lenses 441.
Optimal observation distance D: 500 mm
Lens pitch of lenticular lens 3: 0.238 mm
Refractive index n1 of low refractive index layer 402: 1.41
Refractive index (lens refractive index) n2 of optical filter layer: 1.52
Array pitch (lens pitch) of lens array 440: 40 μm
Position of lens array 440: 0.5 mm from a lenti surface
Light beam control angle θa: ±6 degrees
Focal length: 0.19 mm
Height (lens height) h of optical filter layer before being blazed: 14.5 μm
Height (lens height) h of optical filter layer after being blazed: 4.8 μm

FIG. 61 illustrates a comparison between a general cylindrical lens 431 and a blazed cylindrical lens 441. The blazing allows the cylindrical lens 441 to have a thinner thickness than the general cylindrical lens 431. This makes it possible to obtain the thin optical filter 4. It is to be noted that it is also possible to use multiple-level phase type cylindrical lenses. In addition, when using the stereoscopic display device according to the ninth specific example, it is possible to accurately control angles of output light beams and obtain an angular distribution with no lasting effect.

### Tenth Specific Example

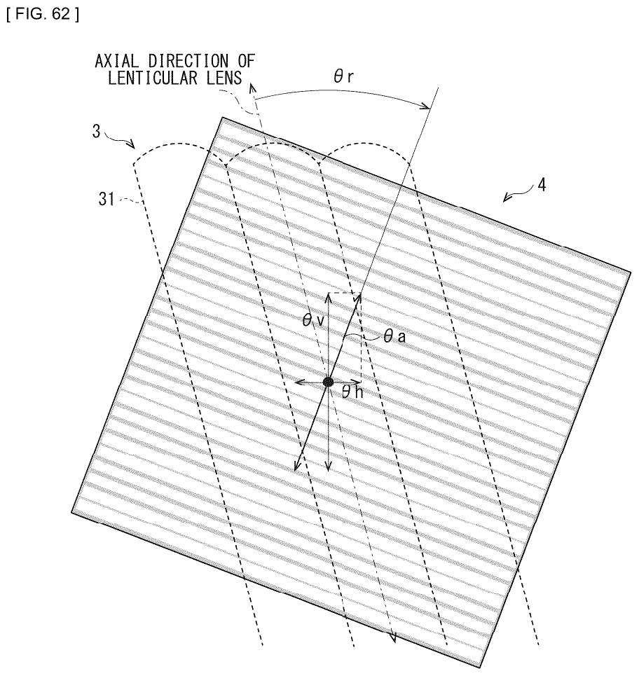

FIG. 62 schematically illustrates a configuration example of an optical filter 4 of a stereoscopic display device according to a tenth specific example.

The optical filter 4 may be disposed to be inclined relative to the axial direction of the lenticular lens 3. For example, when an arrangement angle of the optical filter 4 is rotated Or degrees with respect to the axis of the lenticular lens 3, a light beam control angle θh in the horizontal direction and a light beam control angle θv in the vertical direction are represented as follows.

$$θ h = θ a \cdot cos θ r$$

$$θ v = θ a \cdot sin θ r$$

By rotating the optical filter 4, a component of the light beam control angle θh in the horizontal direction and a component of the light beam control angle θv in the vertical direction are generated as the light beam control angle θa. This achieves a similar effect as adding anisotropy to the light beam control angle of the optical filter 4. In addition, when using the stereoscopic display device according to the tenth specific example, it is possible to accurately control angles of output light beams, obtain an angular distribution with no lasting effect, and suppress crosstalk.

### 11th Specific Example

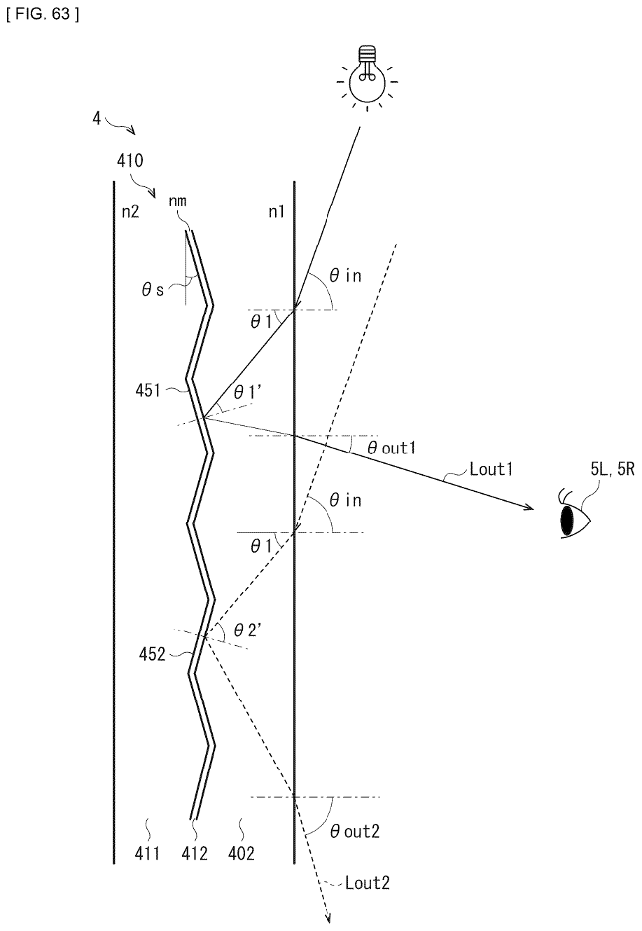

FIG. 63 schematically illustrates a configuration example of an optical filter 4 of a stereoscopic display device according to an 11th specific example.

The optical filter 4 may include an optical filter layer, a low refractive index layer 402 having a lower refractive index than the refractive index n2 of the optical filter layer, and an intermediate layer 412 stacked between the optical filter layer and the low refractive index layer 402. The intermediate layer 412 has a refractive index nm that is lower than the refractive index n2 of the optical filter layer and higher than the refractive index n1 of the low refractive index layer 402. FIG. 63 illustrates a configuration example of the optical filter that is a triangle prism array 410 in which a plurality of triangle prisms 411 is parallelly arrayed.

For example, the intermediate layer 412 having a refractive index of nm=√(n1·n2) may be provided on a boundary between the optical filter layer having the refractive index n2 and the low refractive index layer 402 having the refractive index n1. It is possible to suppress interface reflection by forming a film through vapor deposition, sputtering, or the like in such a manner that the intermediate layer 412 has a thickness that is an odd multiple of 24.

Here, detailed design values of the optical filter 4 that makes it possible to suppress interface reflection will be listed. The light beam control angle θa is set to an angle in a cross-section in the array direction of the plurality of triangle prisms 411. The optical filter is a triangle prism array 410 in which triangle prisms 411 having substantially triangular shapes are parallelly arrayed. The triangle prism 411 has a first inclined surface 451 and a second inclined surface 452.
Refractive index n1 of low refractive index layer 402: 1.41 (silicone OCA)
Refractive index (prism refractive index) n2 of optical filter layer: 1.52 (UV curable resin)
Refractive index nm of intermediate layer 412: 1.46 (SiO2)
Angle of inclined surface of prism: θs=17.5 degrees
Incidence angle θin of outside light: 45 to 85 degrees
Incidence angle θ1′ of outside light on first inclined surface 451: 12.6 degrees to 27.5 degrees
Incidence angle θ2′ of outside light on second inclined surface 452: 47.6 degrees to 62.5 degrees
Output angle θout1 of light beam from first inclined surface 451: −6.9 degrees to 14.1 degrees
(An output light Lout2 from the second inclined surface 452 is totally reflected by the low refractive index layer 402 and the air layer or does not enter a field of view of the observer even if the output light Lout2 passes through the low refractive index layer 402 and the air layer)

The incidence angle θ1′ of outside light on the first inclined surface 451 and the incidence angle θ2′ of outside light on the second inclined surface 452 are represented by the following expressions.

$$θ {1}^{′} = {sin}^{- 1} ( 1 / n 1 \cdot sin θ in ) - θ s \\ θ {2}^{′} = {sin}^{- 1} ( 1 / n 1 \cdot sin θ in ) + θ s$$

In addition, the angle θout1 of output light Lout1 from the first inclined surface 451 and an angle θout2 of output light Lout2 from the second inclined surface 452 are represented by the following expressions.

$$θout 1 = {sin}^{- 1} [ n 1 \cdot sin \{ {sin}^{- 1} ( 1 / n 1 \cdot sin θ in ) - 2 θ s \} ] \\ θout 2 = {sin}^{- 1} [ n 1 \cdot sin \{ {sin}^{- 1} ( 1 / n 1 \cdot sin θ in ) + 2 θ s \} ]$$

Here, for example, the intermediate layer 412 has a layer thickness t of 98 nm in a case where the optical filter 4 is designed in such a manner that an incidence angle θc of a light beam on the first inclined surface 451 satisfies θc=22 deg, k=1, and λ=530 nm with regard to the following expression.

$$t = k \cdot λ / ( 4 nm \cdot cos θ c )$$

where k represents an odd number.

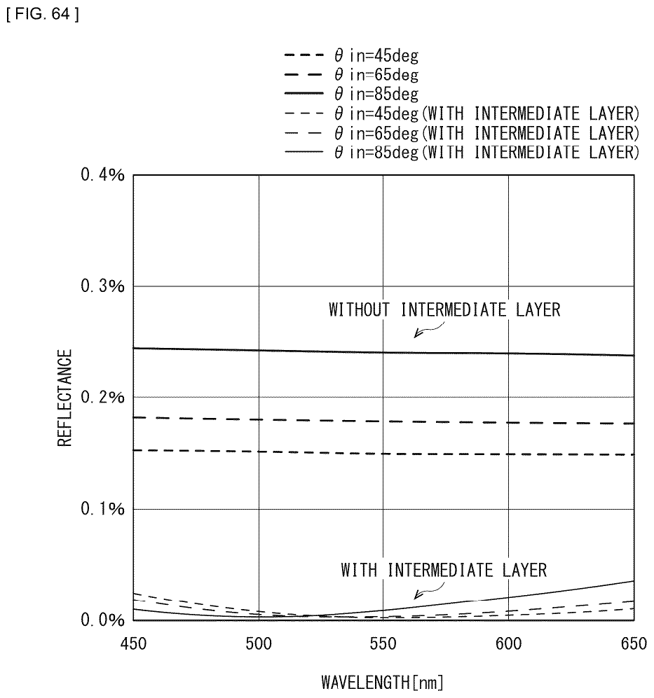

FIG. 64 illustrates interface reflectance of the triangle prism array 410 of the optical filter 4 of the stereoscopic display device according to the 11th specific example. In FIG. 64, a horizontal axis represents wavelength, and a vertical axis represents the reflectance. FIG. 64 illustrates interface reflectances obtained in a case where the intermediate layer 412 is provided and interface reflectances obtained in a case where the intermediate layer 412 is not provided.

As can be understood from FIG. 64, it is possible to reduce the interface reflectance by providing the intermediate layer 412. It is possible to prevent image quality deterioration by reducing effects of reflection of output light. It is to be noted that the intermediate layer 412 may be an antireflective (AR) film including a plurality of low reflection layers or an AR layer including a moth-eye structure or the like.

It is to be noted that, in a case where a film thickness of the triangle prism array 410 becomes uneven between a protrusion and a recess due to variability on film formation, corrections is preferably performed by using Δnh=(n2−n1)h2+(nm−n1)(ha−hb) according to an expression (3) listed below.

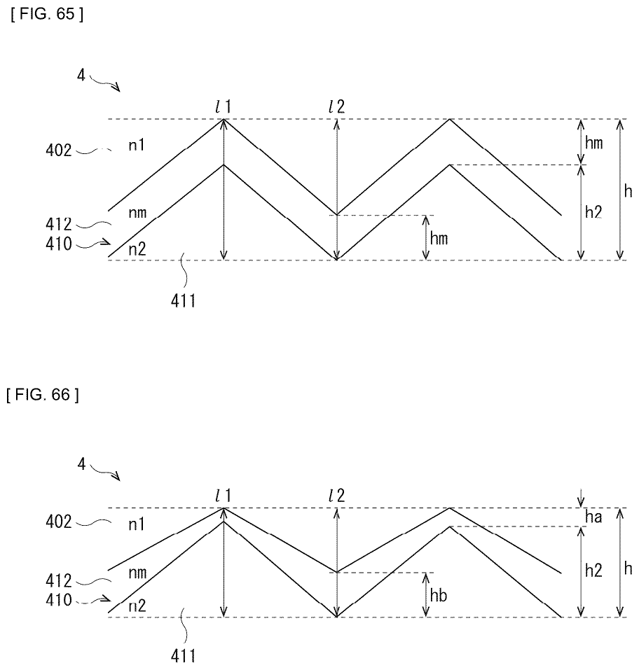

FIG. 65 schematically illustrating a configuration example in which the optical filter 4 of the stereoscopic display device according to the 11th specific example includes a uniform intermediate layer 412. When uniform film formation is achieved with regard to the intermediate layer 412, Δnh is represented as follows.

$$\begin{matrix}Δ n h = l 1 - l 2 = n 2 \cdot h 2 + nm \cdot h m - nm \cdot h m - n 1 \cdot h \\ = ( n 2 - n 1 ) h 2\end{matrix}$$

where 11 represents an optical path length of the protrusion side, and 11 represents an optical path length of the recess side.

$$l 1 = n 2 \cdot h 2 + nm \cdot h m \\ l 2 = nm \cdot h m + n 1 \cdot h 2$$

Alternatively, FIG. 66 schematically illustrating a configuration example in which the optical filter 4 of the stereoscopic display device according to the 11th specific example includes a non-uniform intermediate layer 412. When non-uniform film formation is achieved with regard to the intermediate layer 412, Δnh is represented as follows.

$$l 1 = n 2 \cdot h 2 + nm \cdot h a l 2 = nm \cdot h b + n 1 ( h a + h 2 - h b ) \begin{matrix}Δ nh = l 1 - l 2 \\ = n 2 \cdot h 2 + nm \cdot h a - nm \cdot h b - n 1 ( ha + h 2 - h b ) \\ = ( n 2 - n 1 ) h 2 + ( nm - n 1 ) ( ha - hb )\end{matrix} \qquad ( 3 )$$

### 12th Specific Example

As the optical filter layer, the optical filter 4 may include a prism array including a plurality of prisms that is two-dimensionally disposed in the horizontal direction and the vertical direction. In this case, in a case where Pa≤25 μm holds true, where Pa represents an array pitch of the prism array in at least one of the horizontal direction or the vertical direction, the optical filter 4 may be configured in such a manner that the above-described conditional expressions (1) and (2) with regard to the light beam control angle θa of the optical filter 4 in at least one of the horizontal direction or the vertical direction are satisfied.

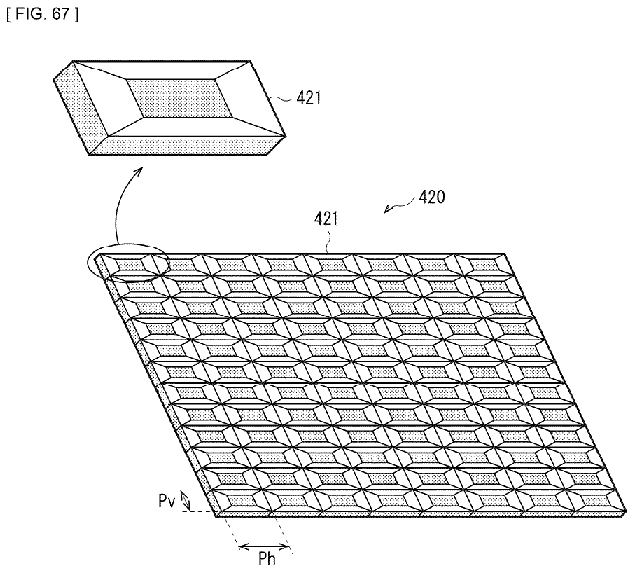

FIG. 67 schematically illustrates a first configuration example of an optical filter 4 of a stereoscopic display device according to a 12th specific example. FIG. 67 illustrates a configuration example of the optical filter 4 including a trapezoidal prism array 420. In the configuration example illustrated in FIG. 67, a trapezoidal prism 421 having a rectangular planar shape is treated as a unit cell, and the trapezoidal prism array 420 includes a plurality of the trapezoidal prisms 421 serving as the unit cells that are two-dimensionally disposed in the horizontal direction and the vertical direction.

Here, detailed design values of the configuration example illustrated in FIG. 67 will be listed. It is to be noted that a low refractive index layer 402 is stacked on the trapezoidal prism array 420 in a way similar to the configuration example illustrated in FIG. 46.
Lens pitch of lenticular lens 3: 0.143 mm
Design dominant wavelength λ: 0.53 μm
Position of trapezoidal prism array 420: 2.75 mm from top surface of lenticular lens 3
Refractive index n1 of low refractive index layer 402: 1.41
Refractive index (prism refractive index) n2 of optical filter layer: 1.52
Array pitch (prism pitch) Ph in horizontal direction: 40 μm
Light beam control angle θh in horizontal direction: ±0.8 degrees
Array pitch (prism pitch) Pv in vertical direction: 15.2 μm
Light beam control angle θv in vertical direction: ±2 degrees
Height (prism height) h of optical filter layer: 2.9 μm
Diffraction order m: 1
Phase difference δ=Δnh·2π/λ: 1.2

In this design example, the array pitch Ph in the horizontal direction satisfies Ph>25 μm, and the array pitch Ph is designed under a condition that a usual prism refraction angle is used regardless of the influence of diffraction. The array pitch Pv in the vertical direction satisfies Pv≤25 μm, and the array pitch Pv is designed under a condition that a diffraction angle satisfies the above-described conditional expressions (1) and (2) in consideration of the influence of diffraction.

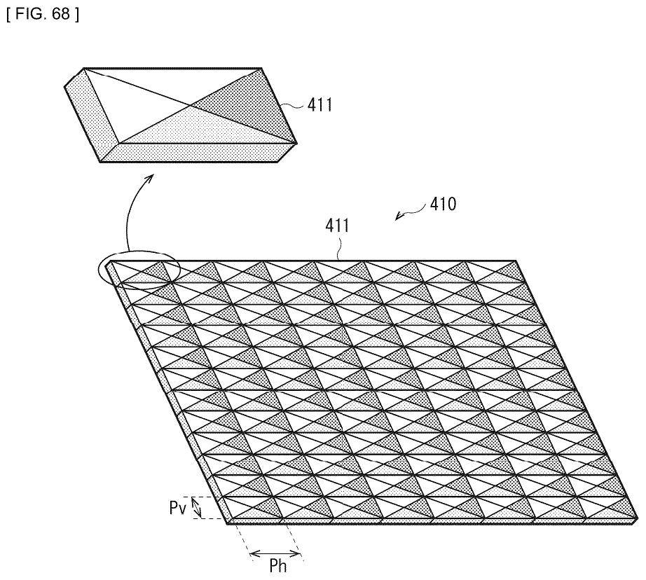

FIG. 68 schematically illustrates a second configuration example of the optical filter 4 of the stereoscopic display device according to the 12th specific example. FIG. 68 illustrates a configuration example of the optical filter 4 including a triangle prism array 410. In the configuration example illustrated in FIG. 68, a triangle prism 411 having a rectangular planar shape is treated as a unit cell, and the triangle prism array 410 includes a plurality of the triangle prisms 411 serving as the unit cells that are two-dimensionally disposed in the horizontal direction and the vertical direction.

Here, detailed design values of the configuration example illustrated in FIG. 68 will be listed. It is to be noted that a low refractive index layer 402 is stacked on the triangle prism array 410 in a way similar to the configuration example illustrated in FIG. 45.
Lens pitch of lenticular lens 3: 0.238 mm
Design dominant wavelength λ: 0.53 μm
Position of triangle prism array 410: 0.85 mm from top surface of lenticular lens 3
Refractive index n1 of low refractive index layer 402: 1.41
Refractive index (prism refractive index) n2 of optical filter layer: 1.52
Array pitch (prism pitch) Ph in horizontal direction: 37 μm
Light beam control angle θh in horizontal direction: ±1.5 degrees
Array pitch (prism pitch) Pv in vertical direction: 17.4 μm
Light beam control angle θv in vertical direction: ±3.5 degrees
Height (prism height) h of optical filter layer: 4.5 μm
Diffraction order m: 2
Phase difference δ=Δnh·2π/λ: 1.85π

In this design example, the array pitch Ph in the horizontal direction satisfies Ph>25 μm, and the array pitch Ph is designed under a condition that a usual prism refraction angle is used regardless of the influence of diffraction. The array pitch Pv in the vertical direction satisfies Pv≤25 μm, and the array pitch Pv is designed under a condition that a diffraction angle satisfies the above-described conditional expressions (1) and (2) in consideration of the influence of diffraction.

The stereoscopic display device according to the 12th specific example is able to generate a component of the light beam control angle θh in the horizontal direction and a component of the light beam control angle θv in the vertical direction as the light beam control angle, since the stereoscopic display device is configured in such a manner that the plurality of prisms is two-dimensionally disposed in the horizontal direction and the vertical direction as the prism array of the optical filter 4. This achieves a similar effect as adding anisotropy to the light beam control angle of the optical filter 4. In addition, when using the stereoscopic display device according to the 12th specific example, it is possible to accurately control angles of output light beams, obtain an angular distribution with no lasting effect, and suppress crosstalk.

### 13th Specific Example

As the optical filter layer, the optical filter 4 may include a lens array including a plurality of lenses that is two-dimensionally disposed in the horizontal direction and the vertical direction. In this case, in a case where Pa≤25 μm holds true, where Pa represents an array pitch of the lens array in at least one of the horizontal direction or the vertical direction, the optical filter 4 may be configured in such a manner that the above-described conditional expressions (1) and (2) with regard to the light beam control angle θa of the optical filter 4 in at least one of the horizontal direction or the vertical direction are satisfied.

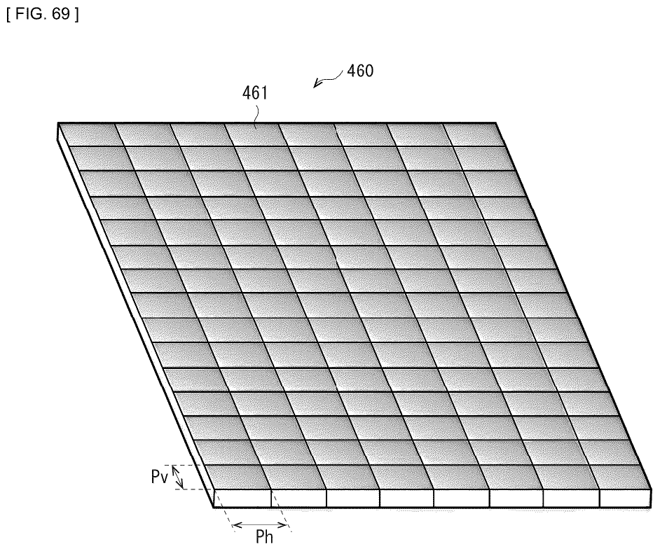

FIG. 69 schematically illustrates a first configuration example of the optical filter 4 of the stereoscopic display device according to the 13th specific example. FIG. 69 illustrates a configuration example of the optical filter 4 including a micro lens array (MLA) 460. In the configuration example illustrated in FIG. 69, a micro lens 461 having a rectangular planar shape is treated as a unit cell, and the micro lens array 460 includes a plurality of the micro lenses 461 serving as the unit cells that are two-dimensionally disposed in the horizontal direction and the vertical direction.

Here, detailed design values of the configuration example illustrated in FIG. 67 will be listed. It is to be noted that a low refractive index layer 402 is stacked on the micro lens array 460 in a way similar to the configuration example illustrated in FIG. 47.
Lens pitch of lenticular lens 3: 0.143 mm
Position of micro lens array 460: 2.75 mm from top surface of lenticular lens 3
Refractive index n1 of low refractive index layer 402: 1.41
Refractive index (lens refractive index) n2 of optical filter layer: 1.52
Array pitch (lens pitch) Ph in horizontal direction: 30 μm
Focal length fh in horizontal direction: 1.72 mm
Light beam control angle θh in horizontal direction: ±0.5 degrees
Array pitch (lens pitch) Pv in vertical direction: 30 μm
Focal length fv in vertical direction: 0.39 mm
Light beam control angle θv in vertical direction: ±2.2 degrees

Here, the focal length of the micro lens array 460 is set in such a manner that a light beam at a lens pitch end has a predetermined output angle. In addition, the focal length in the horizontal direction is different from the focal length in the vertical direction as will be described below, where fh represents the focal length in the horizontal direction, and fv represents the focal length in the vertical direction.

$$fh = Ph / 2 tan θ h \\ fv = Pv / 2 tan θ v$$

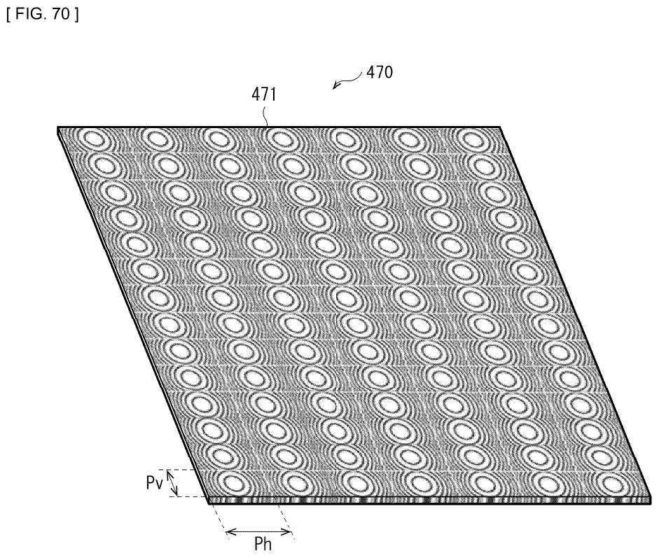

FIG. 70 schematically illustrates a second configuration example of the optical filter 4 of the stereoscopic display device according to the 13th specific example.

As the optical filter layer, the optical filter 4 may include a lens array including a plurality of blazed lenses that is two-dimensionally disposed in the horizontal direction and the vertical direction. FIG. 70 illustrates a configuration example of the optical filter 4 including a Fresnel lens array 470. In the configuration example illustrated in FIG. 70, a Fresnel lens 471 having a rectangular planar shape is treated as a unit cell, and the Fresnel lens array 470 includes a plurality of the Fresnel lenses 471 serving as the unit cells that are two-dimensionally disposed in the horizontal direction and the vertical direction.

The stereoscopic display device according to the 13th specific example is able to generate a component of the light beam control angle θh in the horizontal direction and a component of the light beam control angle θv in the vertical direction as the light beam control angle, since the stereoscopic display device is configured in such a manner that the plurality of lenses is two-dimensionally disposed in the horizontal direction and the vertical direction as the lens array of the optical filter 4. This achieves a similar effect as adding anisotropy to the light beam control angle of the optical filter 4. In addition, when using the stereoscopic display device according to the 13th specific example, it is possible to accurately control angles of output light beams, obtain an angular distribution with no lasting effect, and suppress crosstalk.

### 14th Specific Example

As the optical filter layer, the optical filter 4 may include a prism array including a plurality of prisms that is two-dimensionally disposed at random in the horizontal direction and the vertical direction. Alternatively, as the optical filter layer, the optical filter 4 may include a lens array (two-dimensionally disposed random lens array) including a plurality of lenses that is two-dimensionally disposed at random in the horizontal direction and the vertical direction.

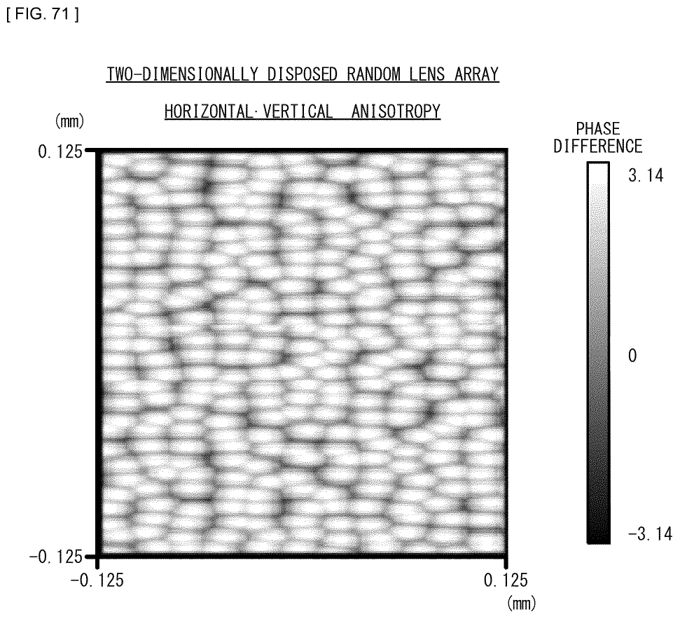

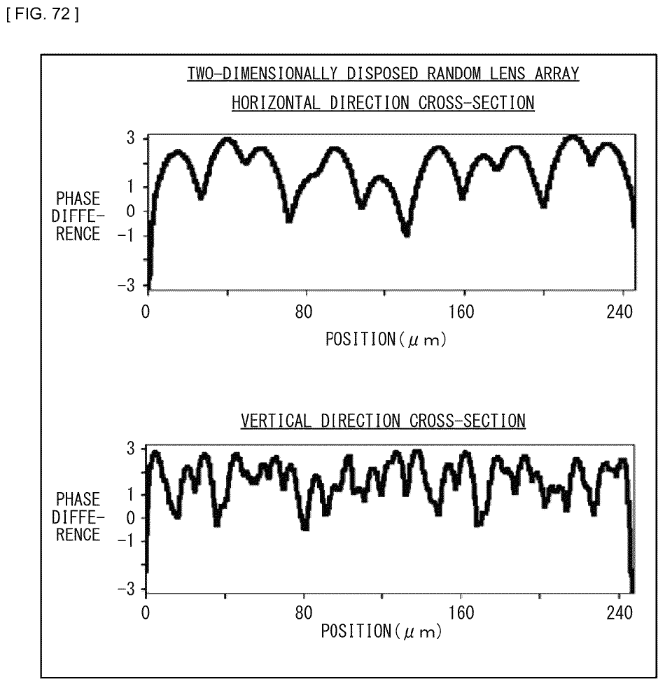

FIG. 71 and FIG. 72 schematically illustrates an example of phase difference distribution of phase difference caused with regard to a first configuration example of an optical filter of a stereoscopic display device according to a 14th specific example. FIG. 71 and FIG. 72 illustrate an example of the phase difference distribution obtained in a case where the optical filter 4 includes the two-dimensionally disposed random lens array. In addition, FIG. 71 and FIG. 72 illustrate an example of the phase difference distribution obtained in a case where the light beam control angle in the horizontal direction is different from the light beam control angle of the vertical direction (anisotropy is added). FIG. 71 illustrates a two-dimensional phase difference distribution. FIG. 72 illustrates a phase difference distribution in a cross-section taken along the horizontal direction, and a phase difference distribution in a cross-section taken along the vertical direction.

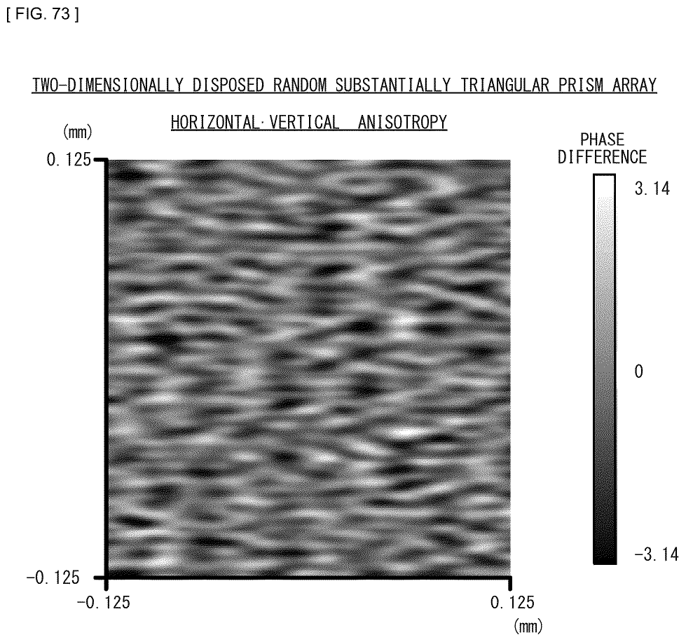

FIG. 73 and FIG. 74 schematically illustrates an example of phase difference distribution of phase difference caused with regard to a second configuration example of the optical filter of the stereoscopic display device according to the 14th specific example. FIG. 73 and FIG. 74 illustrate an example of the phase difference distribution obtained in a case where the optical filter 4 includes a prism array (two-dimensionally disposed random substantially triangular prism array) including a plurality of substantially triangular prisms that is two-dimensionally disposed at random in the horizontal direction and the vertical direction. In addition, FIG. 73 and FIG. 74 illustrate an example of the phase difference distribution obtained in a case where the light beam control angle in the horizontal direction is different from the light beam control angle of the vertical direction (anisotropy is added). FIG. 73 illustrates a two-dimensional phase difference distribution. FIG. 74 illustrates a phase difference distribution in a cross-section taken along the horizontal direction, and a phase difference distribution in a cross-section taken along the vertical direction.

Here, detailed design values thereof will be listed. It is to be noted that a low refractive index layer 402 is stacked on the optical filter layer in a way similar to the configuration example illustrated in FIG. 45.
Lens pitch of lenticular lens 3: 0.238 mm
Design dominant wavelength λ: 0.53 μm
Position of optical filter layer: 0.85 mm from top surface of lenticular lens 3
Refractive index n1 of low refractive index layer 402: 1.41
Refractive index (prism refractive index) n2 of optical filter layer: 1.52

It is to be noted that, in the case where the optical filter layer is the two-dimensionally disposed random lens array, the array pitch (lens pitch) Ph in the horizontal direction has a different value from the array pitch (lens pitch) Pv in the vertical direction and a lens curvature in the horizontal direction has a different value from a lens curvature in the vertical direction, which makes it possible to add anisotropy to the light beam control angle. FIG. 71 and FIG. 73 illustrate a design example in which the light beam control angle is controlled on the basis of array pitch and the phase difference δ.

The stereoscopic display device according to the 14th specific example is able to generate a component of the light beam control angle θh in the horizontal direction and a component of the light beam control angle θv in the vertical direction as the light beam control angle, since the optical filter layer is configured in such a manner that the plurality of prisms or lenses is two-dimensionally disposed at random in the horizontal direction and the vertical direction. This makes it possible to add anisotropy to the light beam control angle of the optical filter 4. In addition, when using the stereoscopic display device according to the 14th specific example, it is possible to accurately control angles of output light beams, obtain an angular distribution with no lasting effect, and suppress crosstalk.

### 1.3 Effects

As described above, the stereoscopic display device according to the first embodiment of the present disclosure controls diffusion angles of light beams output from the lenticular lens 3 toward the plurality of viewpoint positions in such a manner that the diffusion angles fall within a predetermined angular range decided on the basis of the plurality of viewpoint positions. This makes it possible to improve image quality. In particular, it is possible to reduce optical moiré without worsening the crosstalk.

It is to be noted that the effects described herein are only for illustrative purposes and there may be other effects. The same applies to effects according to other embodiments to be described below.

### 2. Second Embodiment

Next, a stereoscopic display device according to a second embodiment of the present disclosure will be described. It is to be noted that, hereinafter, structural elements that are substantially same as the structural elements of the stereoscopic display device according to the above-described first embodiment will be denoted with a same reference signs as the above-described first embodiment, and repeated description will be omitted appropriately.

### (First Configuration)

FIG. 75 is a cross-sectional diagram schematically illustrating a configuration example of a stereoscopic display device according to a second embodiment. FIG. 76 is a cross-sectional diagram schematically illustrating a first configuration example of a surface of a lenticular lens 3 of the stereoscopic display device according to the second embodiment.

A surface of the lenticular lens 3 of the stereoscopic display deice according to the second embodiment is processed to function as an optical filter. The optical filter formed on the surface of the lenticular lens 3 controls diffusion angles of light beams output from the lenticular lens 3 in such a manner that the diffusion angles fall within a predetermined angular range decided on the basis of the plurality of viewpoint positions, in a way similar to the optical filter 4 of the stereoscopic display device according to the first embodiment.

For example, as illustrated in FIG. 75 and FIG. 76, a fine recessed and projected layer 70 is provided on the surface of the lenticular lens 3. The fine recessed and projected layer 70 has a plurality of fine recessed and projected shapes 71 that functions as the optical filter. The fine recessed and projected shapes 71 are formed in a direction parallel to the array of the lenticular lens 3.

Here, detailed design values of the first configuration example of the surface of the lenticular lens 3 will be listed.
Lens pitch of lenticular lens 3: 0.143 mm
Pitch of fine recessed and projected shape 71: 0.019 mm on average
Light beam control angle θh in horizontal direction: ±0.5 degrees

For example, a recessed and projected of the fine recessed and projected shape 71 is a step of about 0.1 μm, and a radius of its curvature is about 0.36 mm. The fine recessed and projected shape 71 may be obtained depending on the shape of a cutting tool used for forming a mold, may be obtained through hairline finishing after forming the mold, or may be obtained in other ways. The fine recessed and projected shape 71 has random pitch in the case of the hairline finishing or the like.

### (Second Configuration)

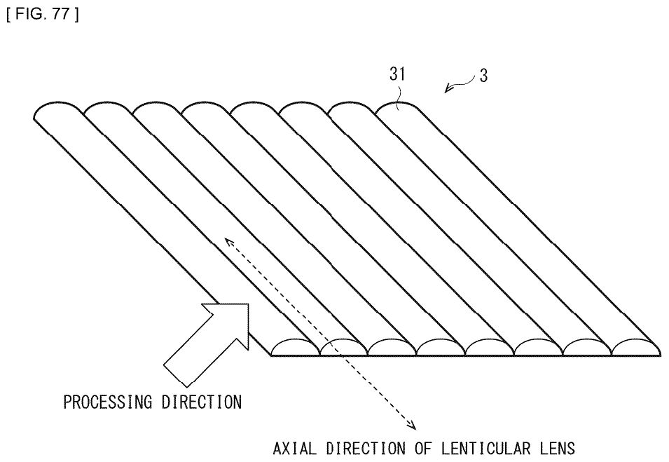

FIG. 77 is a configuration diagram schematically illustrating a second configuration example of the surface of the lenticular lens 3 of the stereoscopic display device according to the second embodiment.

The fine recessed and projected shapes 71 may be formed in a direction perpendicular to the array of the lenticular lens 3. The fine recessed and projected shapes 71 function as the optical filter.

Here, detailed design values of the second configuration example of the surface of the lenticular lens 3 will be listed.
Lens pitch of lenticular lens 3: 0.143 mm
Pitch of fine recessed and projected shape 71: 0.019 mm on average
Light beam control angle θh in horizontal direction: ±1.5 degrees

For example, a recessed and projected of the fine recessed and projected shape 71 is a step of about 0.4 μm. The fine recessed and projected shape 71 is obtained through hairline finishing or the like after forming a mold. The fine recessed and projected shape 71 has random pitch in the case of the hairline finishing or the like.

Other configurations, actions, and effects may be substantially similar to those in the stereoscopic display device according to the first embodiment described above.

### 3. Other Embodiments

The technology according to the present disclosure is not limited to the above-described embodiments, and various kinds of modifications thereof can be made.

For example, the present technology may be configured as follows. According to the present technology having the following configurations, it is possible to control diffusion angles of light beams outputted from an optical element toward a plurality of viewpoint positions in such a manner that the diffusion angles fall within a predetermined angular range decided on the basis of the plurality of viewpoint positions. This makes it possible to improve image quality.
(1)
A stereoscopic display device including:
an image display element that displays a plurality of viewpoint images;
an optical element that is opposed to the image display element, and outputs a plurality of light beams corresponding to the respective viewpoint images toward respective viewpoint positions; and
an optical filter that is disposed between the optical element and the plurality of view point positions, and controls diffusion angles of the light beams outputted from the optical element in such a manner that the diffusion angles fall within a predetermined angular range decided on the basis of the plurality of viewpoint positions.
(2)
The stereoscopic display device according to (1), in which a light beam control angle of the optical filter in a horizontal direction is ½ or less of a viewpoint angle made by a surface of the optical filter and two viewpoint positions corresponding to a left eye position and a right eye position among the plurality of viewpoint positions.
(3)
The stereoscopic display device according to (1) or (2), in which the optical filter has anisotropy with regard to the light beam control angle in the horizontal direction and a light beam control angle in a vertical direction.
(4)
The stereoscopic display device according to any one of (1) to (3), in which
the optical element includes a lenticular lens including a plurality of lenses that is disposed to be inclined, and
a light beam control angle of the optical filter in a vertical direction is less than or equal to a value obtained by multiplying ½ of a viewpoint angle by a ratio decided by an inclination angle of the lenticular lens, the viewpoint angle being made by a surface of the optical filter and two viewpoint positions corresponding to a left eye position and a right eye position among the plurality of viewpoint positions.
(5)
The stereoscopic display device according to any one of (1) to (4), in which
the image display element includes a plurality of subpixels, the optical element includes a lenticular lens including a plurality of lenses that is disposed to be inclined, and
a light beam control angle of the optical filter in an axial direction of the lenticular lens is less than an angle decided by a subpixel pitch of the image display element in the axial direction of the lenticular lens and a distance between a top surface of the optical filter and a top surface of the lenticular lens.
(6)
The stereoscopic display device according to any one of (1) to (5), in which the optical filter includes a prism array including a plurality of prisms.
(7)
The stereoscopic display device according to (6), in which
Pa≤25 μm holds true, where Pa represents an array pitch of the prism array, and
the following conditional expressions with regard to a light beam control angle θa of the optical filter are satisfied,

$$θ a = {sin}^{- 1} ( m λ / Pa ) \qquad ( 1 )$$

$$0.9 m π \leq δ \leq 0.9 ( m + 1 ) π \qquad ( 2 )$$

where m represents a diffraction order number (integer) of diffracted light caused by the prism array,
λ represents a dominant wavelength of a light beam that enters the optical filter, and
δ represents a phase difference caused by passing of the light beam having entered the optical filter through the prism array.
(8)
The stereoscopic display device according to any one of (1) to (5), in which the optical filter includes a lens array including a plurality of cylindrical lenses.
(9)
The stereoscopic display device according to (8), in which a light beam control angle of the optical filter is an angle decided on the basis of the plurality of viewpoint positions and an array pitch of the lens array.
(10)
The stereoscopic display device according to (8), in which
Pa≤25 μm holds true, where Pa represents an array pitch of the prism array, and the following conditional expressions with regard to a light beam control angle θa of the optical filter are satisfied,

$$θ a = {sin}^{- 1} ( m λ / Pa ) \qquad ( 1 )$$

$$0.9 m π \leq δ \leq 0.9 ( m + 1 ) π \qquad ( 2 )$$

where m represents a diffraction order number (integer) of diffracted light caused by the prism array,
λ represents a dominant wavelength of a light beam that enters the optical filter, and
δ represents a phase difference caused by passing of the light beam having entered the optical filter through the prism array.
(11)
The stereoscopic display device according to any one of (8) to (10), in which each of the plurality of cylindrical lenses in the lens array includes a blazed cylindrical lens.
(12)
The stereoscopic display device according to any one of (1) to (11), in which
the optical element includes a lenticular lens including a plurality of lenses extending in an axial direction, and
the optical filter is inclined to the axial direction of the lenticular lens.
(13)
The stereoscopic display device according to any one of (1) to (12), in which
the optical filter includes
an optical filter layer,
a low refractive index layer having a lower refractive index than a refractive index of the optical filter layer, and
an intermediate layer that is stacked between the optical filter layer and the low refractive index layer, the intermediate layer having a refractive index that is lower than the refractive index of the optical filter layer and higher than the refractive index of the low refractive index layer.
(14)
The stereoscopic display device according to any one of (1) to (5), in which the optical filter includes a prism array including a plurality of prisms that is two-dimensionally disposed in a horizontal direction and a vertical direction.
(15)
The stereoscopic display device according to (14), in which
Pa≤25 μm holds true, where Pa represents an array pitch of the prism array in at least one of the horizontal direction or the vertical direction, and
the following conditional expressions with regard to a light beam control angle θa of the optical filter in at least one of the horizontal direction or the vertical direction are satisfied,

$$θ a = {sin}^{- 1} ( m λ / Pa ) \qquad ( 1 )$$

$$0.9 m π \leq δ \leq 0.9 ( m + 1 ) π \qquad ( 2 )$$

where m represents a diffraction order number (integer) of diffracted light caused by the prism array,
λ represents a dominant wavelength of a light beam that enters the optical filter, and
δ represents a phase difference caused by passing of the light beam having entered the optical filter through the prism array.
(16)
The stereoscopic display device according to any one of (1) to (5), in which the optical filter includes a lens array including a plurality of lenses that is two-dimensionally disposed in a horizontal direction and a vertical direction.
(17)
The stereoscopic display device according to (16), in which the lens array includes the plurality of lenses that is two-dimensionally disposed at random in the horizontal direction and the vertical direction.
(18)
The stereoscopic display device according to (16), in which
Pa≤25 μm holds true, where Pa represents an array pitch of the prism array in at least one of the horizontal direction or the vertical direction, and
the following conditional expressions with regard to a light beam control angle θa of the optical filter in at least one of the horizontal direction or the vertical direction are satisfied,

$$θ a = {sin}^{- 1} ( m λ / Pa ) \qquad ( 1 )$$

$$0.9 m π \leq δ \leq 0.9 ( m + 1 ) π \qquad ( 2 )$$

where m represents a diffraction order number (integer) of diffracted light caused by the prism array,
λ represents a dominant wavelength of a light beam that enters the optical filter, and
δ represents a phase difference caused by passing of the light beam having entered the optical filter through the prism array.
(19)
The stereoscopic display device according to any one of (16) to (18), in which each of the plurality of lenses in the lens array includes a blazed lens.
(20)
The stereoscopic display device according to any one of (1) to (19), further including a viewpoint position detection section that detects the plurality of viewpoint positions.
(21)
A stereoscopic display device including:
an image display element that displays a plurality of viewpoint images; and an optical element that is opposed to the image display element, and outputs a plurality of light beams corresponding to the respective viewpoint images toward respective viewpoint positions, in which
a surface of the optical element is processed to function as an optical filter that controls diffusion angles of the light beams outputted from the optical element in such a manner that the diffusion angles fall within a predetermined angular range decided on the basis of the plurality of viewpoint positions.
(22)
The stereoscopic display device according to (21), in which the surface of the optical element has a plurality of recessed and projected shapes that functions as the optical filter.

The present application claims the benefit of Japanese Priority Patent Application JP2021-120758 filed with the Japan Patent Office on Jul. 21, 2021, the entire contents of which are incorporated herein by reference.

It should be understood by those skilled in the art that various modifications, combinations, sub-combinations and alternations may occur depending on design requirements and other factors insofar as they are within the scope of the appended claims or the equivalents thereof.

1. A stereoscopic display device comprising:
an image display element that displays a plurality of viewpoint images;
an optical element that is opposed to the image display element, and outputs a plurality of light beams corresponding to the respective viewpoint images toward respective viewpoint positions; and
an optical filter that is disposed between the optical element and the plurality of view point positions, and controls diffusion angles of the light beams outputted from the optical element in such a manner that the diffusion angles fall within a predetermined angular range decided on a basis of the plurality of viewpoint positions.

2. The stereoscopic display device according to claim 1, wherein a light beam control angle of the optical filter in a horizontal direction is ½ or less of a viewpoint angle made by a surface of the optical filter and two viewpoint positions corresponding to a left eye position and a right eye position among the plurality of viewpoint positions.

3. The stereoscopic display device according to claim 1, wherein the optical filter has anisotropy with regard to the light beam control angle in the horizontal direction and a light beam control angle in a vertical direction.

4. The stereoscopic display device according to claim 1, wherein
the optical element comprises a lenticular lens including a plurality of lenses that is disposed to be inclined, and
a light beam control angle of the optical filter in a vertical direction is less than or equal to a value obtained by multiplying ½ of a viewpoint angle by a ratio decided by an inclination angle of the lenticular lens, the viewpoint angle being made by a surface of the optical filter and two viewpoint positions corresponding to a left eye position and a right eye position among the plurality of viewpoint positions.

5. The stereoscopic display device according to claim 1, wherein
the image display element includes a plurality of subpixels,
the optical element comprises a lenticular lens including a plurality of lenses that is disposed to be inclined, and
a light beam control angle of the optical filter in an axial direction of the lenticular lens is less than an angle decided by a subpixel pitch of the image display element in the axial direction of the lenticular lens and a distance between a top surface of the optical filter and a top surface of the lenticular lens.

6. The stereoscopic display device according to claim 1, wherein the optical filter includes a prism array including a plurality of prisms.

7. The stereoscopic display device according to claim 6, wherein
Pa≤25 μm holds true, where Pa represents an array pitch of the prism array, and
the following conditional expressions with regard to a light beam control angle θa of the optical filter are satisfied,
$$θ a = {sin}^{- 1} ( m λ / Pa ) \qquad ( 1 )$$
$$0.9 m π \leq δ \leq 0.9 ( m + 1 ) π \qquad ( 2 )$$
where m represents a diffraction order number (integer) of diffracted light caused by the prism array,
λ represents a dominant wavelength of a light beam that enters the optical filter, and
δ represents a phase difference caused by passing of the light beam having entered the optical filter through the prism array.

8. The stereoscopic display device according to claim 1, wherein the optical filter includes a lens array including a plurality of cylindrical lenses.

9. The stereoscopic display device according to claim 8, wherein a light beam control angle of the optical filter is an angle decided on a basis of the plurality of viewpoint positions and an array pitch of the lens array.

10. The stereoscopic display device according to claim 8, wherein
Pa≤25 μm holds true, where Pa represents an array pitch of the prism array, and
the following conditional expressions with regard to a light beam control angle θa of the optical filter are satisfied,
$$θ a = {sin}^{- 1} ( m λ / Pa ) \qquad ( 1 )$$
$$0.9 m π \leq δ \leq 0.9 ( m + 1 ) π \qquad ( 2 )$$
where m represents a diffraction order number (integer) of diffracted light caused by the prism array,
λ represents a dominant wavelength of a light beam that enters the optical filter, and
δ represents a phase difference caused by passing of the light beam having entered the optical filter through the prism array.

11. The stereoscopic display device according to claim 8, wherein each of the plurality of cylindrical lenses in the lens array comprises a blazed cylindrical lens.

12. The stereoscopic display device according to claim 1, wherein
the optical element comprises a lenticular lens including a plurality of lenses extending in an axial direction, and
the optical filter is inclined to the axial direction of the lenticular lens.

13. The stereoscopic display device according to claim 1, wherein
the optical filter includes
an optical filter layer,
a low refractive index layer having a lower refractive index than a refractive index of the optical filter layer, and
an intermediate layer that is stacked between the optical filter layer and the low refractive index layer, the intermediate layer having a refractive index that is lower than the refractive index of the optical filter layer and higher than the refractive index of the low refractive index layer.

14. The stereoscopic display device according to claim 1, wherein the optical filter includes a prism array including a plurality of prisms that is two-dimensionally disposed in a horizontal direction and a vertical direction.

15. The stereoscopic display device according to claim 14, wherein
Pa≤25 μm holds true, where Pa represents an array pitch of the prism array in at least one of the horizontal direction or the vertical direction, and
the following conditional expressions with regard to a light beam control angle θa of the optical filter in at least one of the horizontal direction or the vertical direction are satisfied,
$$θ a = {sin}^{- 1} ( m λ / Pa ) \qquad ( 1 )$$
$$0.9 m π \leq δ \leq 0.9 ( m + 1 ) π \qquad ( 2 )$$
where m represents a diffraction order number (integer) of diffracted light caused by the prism array,
λ represents a dominant wavelength of a light beam that enters the optical filter, and
δ represents a phase difference caused by passing of the light beam having entered the optical filter through the prism array.

16. The stereoscopic display device according to claim 1, wherein the optical filter includes a lens array including a plurality of lenses that is two-dimensionally disposed in a horizontal direction and a vertical direction.

17. The stereoscopic display device according to claim 16, wherein the lens array includes the plurality of lenses that is two-dimensionally disposed at random in the horizontal direction and the vertical direction.

18. The stereoscopic display device according to claim 16, wherein
Pa≤25 μm holds true, where Pa represents an array pitch of the prism array in at least one of the horizontal direction or the vertical direction, and
the following conditional expressions with regard to a light beam control angle θa of the optical filter in at least one of the horizontal direction or the vertical direction are satisfied,
$$θ a = {sin}^{- 1} ( m λ / Pa ) \qquad ( 1 )$$
$$0.9 m π \leq δ \leq 0.9 ( m + 1 ) π \qquad ( 2 )$$
where m represents a diffraction order number (integer) of diffracted light caused by the prism array,
λ represents a dominant wavelength of a light beam that enters the optical filter, and
δ represents a phase difference caused by passing of the light beam having entered the optical filter through the prism array.

19. The stereoscopic display device according to claim 16, wherein each of the plurality of lenses in the lens array comprises a blazed lens.

20. The stereoscopic display device according to claim 1, further comprising a viewpoint position detection section that detects the plurality of viewpoint positions.

21. A stereoscopic display device comprising:
an image display element that displays a plurality of viewpoint images; and
an optical element that is opposed to the image display element, and outputs a plurality of light beams corresponding to the respective viewpoint images toward respective viewpoint positions, wherein
a surface of the optical element is processed to function as an optical filter that controls diffusion angles of the light beams outputted from the optical element in such a manner that the diffusion angles fall within a predetermined angular range decided on a basis of the plurality of viewpoint positions.

22. The stereoscopic display device according to claim 21, wherein the surface of the optical element has a plurality of recessed and projected shapes that functions as the optical filter.
